(19) United States
(12) Patent Application Publication
(10) Pub. No.: US 2026/0113793 A1
(43) Pub. Date: Apr. 23, 2026

(54) DUAL CONNECTIVITY FOR XR COMMUNICATIONS

(71) Applicant: QUALCOMM Incorporated, San Diego, CA (US)

(72) Inventors: Mickael MONDET, Louannec (FR); Prasada Veera Reddy KADIRI, San Diego, CA (US); Diana MAAMARI, San Diego, CA (US); Hyun Yong LEE, San Diego, CA (US)

(21) Appl. No.: 18/924,885

(22) Filed: Oct. 23, 2024

(51) Int. Cl. H04W 76/15; H04W 56/00

(52) U.S. Cl. CPC H04W 76/15; H04W 56/0015

(57) ABSTRACT

Dual connectivity (DC) for XR communications is described. An apparatus is configured to receive a PDU set(s) for a UE configured for DC with a first and second network node, and to provide at least one of: a first subset of PDUs for each PDU set and PDU set information for the first subset of PDUs to the second network node, or a second subset of remaining PDUs for each PDU set to the UE. Another apparatus is configured to receive, from a first network node and associated with a PDU set(s) for a UE configured for DC with the first and a second network node, a first subset of PDUs for each PDU set and PDU set information for the first subset of PDUs, and to provide for the UE, in accordance with a PSDB for a PDU set and a PSDB expiry time, the first subset of PDUs.

### TECHNICAL FIELD

The present disclosure relates generally to communication systems, and more particularly, to communication systems utilizing dual connectivity (DC).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be, or may comprise, a first network node as described herein. The apparatus is configured to receive at least one packet data unit (PDU) set for a user equipment (UE) that is configured for DC with the first network node and a second network node, where each PDU set includes one or more PDUs. The apparatus is configured to provide at least one of: a first subset of PDUs for each PDU set of the at least one PDU set and PDU set information respectively associated with the first subset of PDUs for each PDU set to the second network node, or a second subset of remaining PDUs for each PDU set to the UE.

In the aspect, the method includes receiving at least one PDU set for a UE that is configured for DC with the first network node and a second network node, where each PDU set includes one or more PDUs. The method also includes providing at least one of: a first subset of PDUs for each PDU set of the at least one PDU set and PDU set information respectively associated with the first subset of PDUs for each PDU set to the second network node, or a second subset of remaining PDUs for each PDU set to the UE.

In another aspect of the disclosure, a method, a computer-readable medium, and an apparatus are provided. The apparatus may be, or may comprise, a second network node as described herein. The apparatus is configured to receive, from a first network node and associated with at least one PDU set for a UE that is configured for DC with the first network node and the second network node, a first subset of PDUs for each PDU set of the at least one PDU set and PDU set information respectively associated with the first subset of PDUs for each PDU set, where each PDU set includes one or more PDUs. The apparatus is configured to provide, for the UE and in accordance with an indication of a PDU set delay budget (PSDB) for an associated PDU set and a PSDB expiry time for the PDU set information, the first subset of PDUs for each PDU set of the at least one PDU set.

In the aspect, the method includes receiving, from a first network node and associated with at least one PDU set for a UE that is configured for DC with the first network node and the second network node, a first subset of PDUs for each PDU set of the at least one PDU set and PDU set information respectively associated with the first subset of PDUs for each PDU set, where each PDU set includes one or more PDUs. The method also includes providing, for the UE and in accordance with an indication of a PSDB for an associated PDU set and a PSDB expiry time for the PDU set information, the first subset of PDUs for each PDU set of the at least one PDU set.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example extended reality (XR) traffic and an example XR traffic flow.

FIG. 5 is a diagram illustrating example network side protocols in DC.

FIG. 6 is a diagram illustrating an example PDU set delay budget (PSDB) and multi-modal service.

FIG. 7 is a call flow diagram for wireless communications, in accordance with various aspects of the present disclosure.

FIG. 8 is a diagram illustrating an example PSDB with PDU set information for DC, in accordance with various aspects of the present disclosure.

FIG. 9 is a diagram illustrating an example occurrence of a PSDB expiry time and PDU set information for DC, in accordance with various aspects of the present disclosure.

FIG. 10 is a diagram illustrating an example of synchronization threshold management in multi-modal flows for DC, in accordance with various aspects of the present disclosure.

FIG. 11 is a diagram illustrating an example of synchronization threshold management in multi-modal flows for DC, in accordance with various aspects of the present disclosure.

FIG. 12 is a diagram illustrating an example of synchronization threshold management in multi-modal flows for DC, in accordance with various aspects of the present disclosure.

FIG. 13 is a diagram illustrating examples of PDU set/burst ending management for DC, in accordance with various aspects of the present disclosure.

FIG. 14 is a flowchart of a method of wireless communication.

FIG. 15 is a flowchart of a method of wireless communication.

FIG. 16 is a flowchart of a method of wireless communication.

FIG. 17 is a flowchart of a method of wireless communication.

FIG. 18 is a diagram illustrating an example of a hardware implementation for an example apparatus and/or network entity.

FIG. 19 is a diagram illustrating an example of a hardware implementation for an example network entity.

### DETAILED DESCRIPTION

Wireless communication networks may be designed to support communications between network entities (e.g., network nodes such as base stations, eNBs, gNBs, etc.; entities in a core network such as a user plane function (UPF)), UEs, and/or XR devices. Such wireless communications may facilitate service data flows from application servers to UEs/XR devices for XR applications. UEs may be, may comprise, and/or may be paired with XR devices to provide user experiences through XR. Wireless communication networks, such as 5G NR among others, may provide a high-speed, low-latency and high-reliability wireless connectivity which can enable latency-sensitive services like the immersive XR multimedia and cloud computing (e.g., AR Glasses, a VR head-mounted display (HMD), haptic gloves/other tactile equipment, cloud gaming, cloud AI, and/or the like). In some scenarios, dual-modalities for an XR experience may be used, such as for both video and haptic modalities. Such advanced applications may have high levels for operational/system performance parameters to maintain the user experience, including but without limitation, data rate, latency, power consumption, and/or the like (e.g., a stipulated packet delay budget (PDB) of 10 ms for XR traffic packets to maintain the user experience).

However, support of DC scenarios in NR, and beyond, introduce issues that are not accounted for in the current state of the art. For example, with split bearers, a network node (e.g., a Master Node or a Secondary Node) that receives data from a UPF can transmit the data in the master cell group (MCG) and in the secondary cell group (SCG), and if a QoS flow (e.g., for XR) has been configured to carry PDU sets, some of the PDUs can be transmitted in the MCG, while others can be transmitted in the SCG. When a first network node forwards PDUs to a second network node for provision to the UE, current solutions lack mechanisms for the second network node receiving the forwarded PDUs to be aware of information associated with the PSDB/the PSDB expiry time, synchronization thresholds between PDU sets for dual-modalities, end PDU/burst indications, and/or the like. Accordingly, the second network node is unable to efficiently schedule transmission of the forwarded PDUs to the UE, which negatively impacts the XR user experience.

Various aspects relate generally to communication systems utilizing DC. Some aspects more specifically relate to DC for XR communications. In some examples, a first network node may receive, e.g., from a UPF, at least one PDU set for a UE that is configured for DC with the first network node and a second network node. In aspects, each PDU set may include one or more PDUs. The first network node may provide at least one of: a first subset of PDUs for each PDU set of the at least one PDU set and PDU set information respectively associated with the first subset of PDUs for each PDU set to the second network node, or a second subset of remaining PDUs for each PDU set to the UE. In some examples, a second network node may receive, from a first network node and associated with at least one PDU set for a UE that is configured for DC with the first network node and the second network node, a first subset of PDUs for each PDU set of the at least one PDU set and PDU set information respectively associated with the first subset of PDUs for each PDU set, where each PDU set includes one or more PDUs. The second network node may provide, for the UE and in accordance with an indication of a PSDB for an associated PDU set and a PSDB expiry time for the PDU set information, the first subset of PDUs for each PDU set of the at least one PDU set.

Particular aspects of the subject matter described in this disclosure can be implemented to realize one or more of the following potential advantages. In some examples, by providing PDU set information, associated with forwarded first subsets of PDUs for PDU sets to a second network node, as well as information about the PSDB expiry, the described techniques can be used to enable a first network node to inform the second network node of a PDU set expiry time for efficient UE transmission scheduling of first subsets of PDUs in DC. In some examples, by providing associated PDU sets to a UE via a single network node or providing delivery time information for forwarded PDUs from a second to a first network node, the described techniques can be used to enable management of synchronization threshold times in DC. In some examples, by providing information associated with end PDUs of PDU sets/bursts from a first network node to a second network node, the described techniques can be used to enable enhancements for radio resource management (RRM) and scheduling policies for the second network node.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

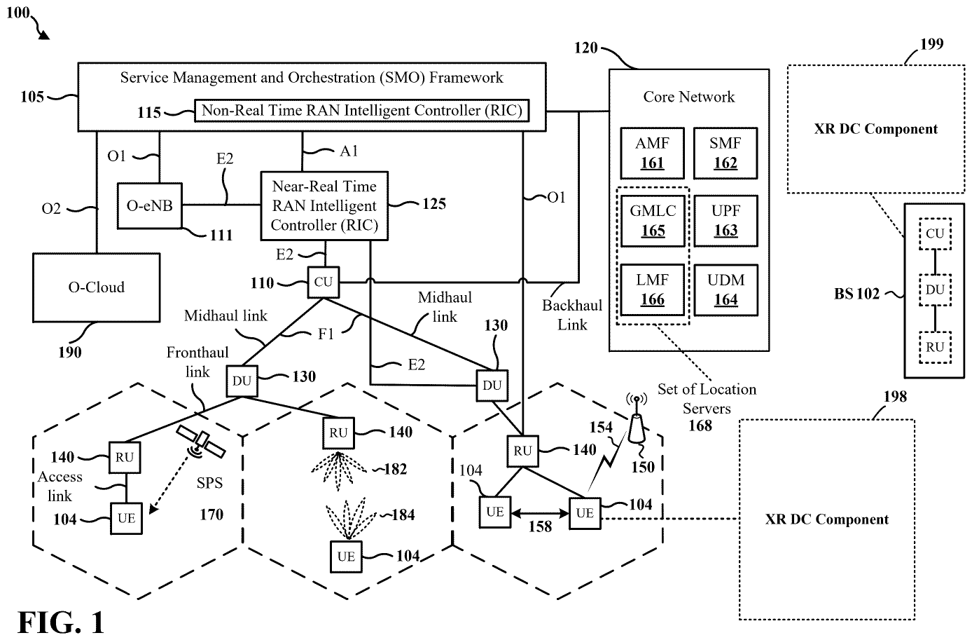

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-NB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHz-7.125 GHZ) and FR2 (24.25 GHz-52.6 GHz). Although a portion of FR1 is greater than 6 GHZ, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the base station 102 may have an XR DC component 199 (“component 199”) that may be configured to receive at least one PDU set for a UE that is configured for DC with the first network node and a second network node, where each PDU set includes one or more PDUs. The component 199 may be configured to provide at least one of: a first subset of PDUs for each PDU set of the at least one PDU set and PDU set information respectively associated with the first subset of PDUs for each PDU set to the second network node, or a second subset of remaining PDUs for each PDU set to the UE. The component 199 may be configured to receive, from the second network node and for each PDU of the first subset of PDUs, delivery time information indicative of a delivery time of the PDU to the UE. The component 199 may be configured to determine whether each PDU of the first subset of PDUs has met a synchronization threshold time based on the delivery time information. In certain aspects, the component 199 may be configured to receive, from a first network node and associated with at least one PDU set for a UE that is configured for DC with the first network node and the second network node, a first subset of PDUs for each PDU set of the at least one PDU set and PDU set information respectively associated with the first subset of PDUs for each PDU set, where each PDU set includes one or more PDUs. The component 199 may be configured to provide, for the UE and in accordance with an indication of a PPSDB for an associated PDU set and a PSDB expiry time for the PDU set information, the first subset of PDUs for each PDU set of the at least one PDU set. The component 199 may be configured to provide, for the first network node and for each PDU of the first subset of PDUs, delivery time information indicative of a delivery time of the PDU to the UE. The component 199 may be configured to determine whether each PDU of the first subset of PDUs has met a synchronization threshold time based on the delivery time information. In certain aspects, the UE 104 may have an XR DC component 198 (“component 198”) that may be configured to receive a first subset of PDUs for each PDU set of at least one PDU set from a second network node, and to receive a second subset of remaining PDUs for each PDU set from a first network node, as described herein. Accordingly, aspects provide for enhanced support of XR with dual connectivity by improving management of PSDBs of PDU sets, synchronization thresholds for multi-modal services, and end PDUs of PDU sets/bursts.

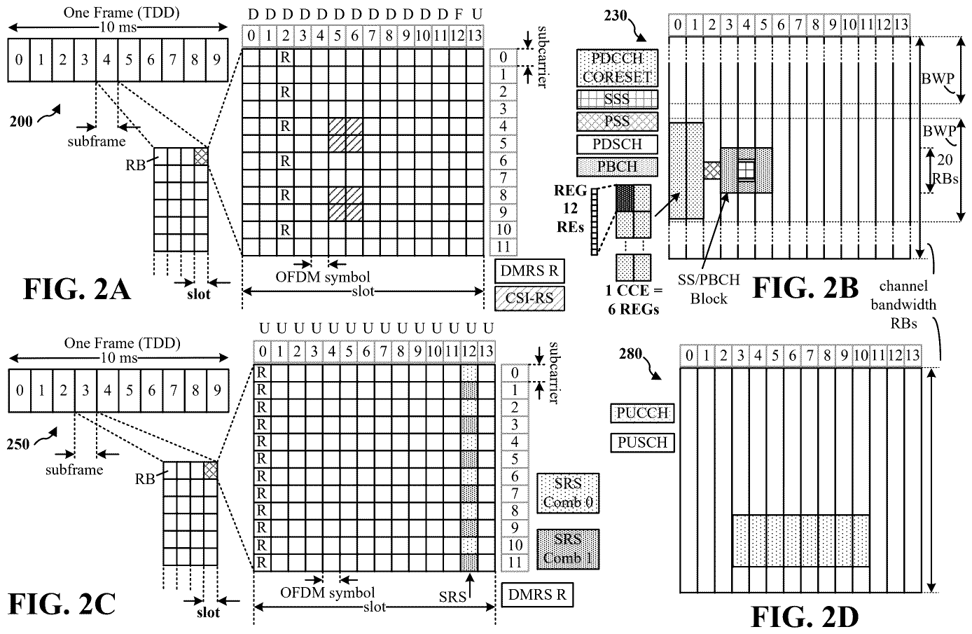

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

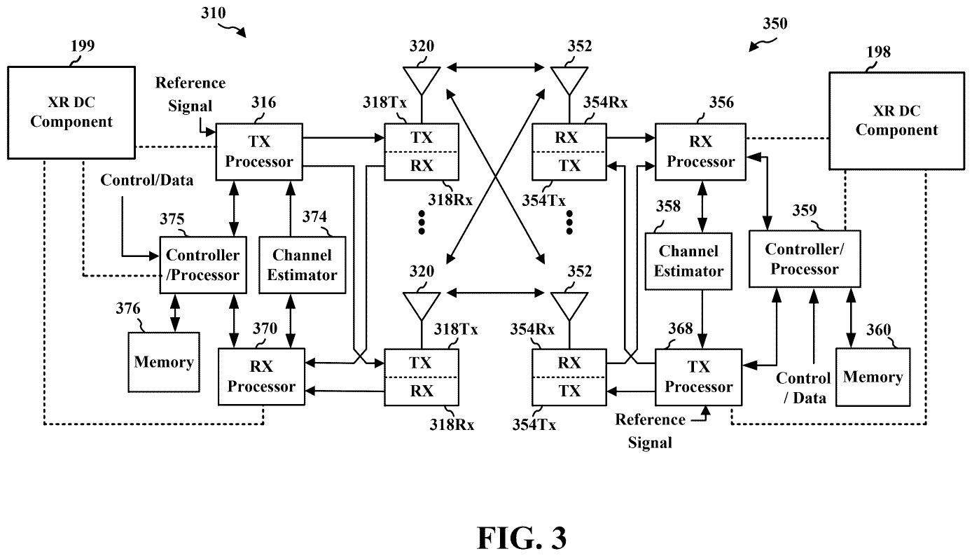

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 316, the RX processor 370, and the controller/processor 375 may be configured to perform aspects in connection with the component 199 of FIG. 1.

At least one of the TX processor 368, the RX processor 356, and the controller/processor 359 may be configured to perform aspects in connection with the component 198 of FIG. 1.

Wireless communications over networks between network entities (e.g., network nodes such as base stations, eNBs, gNBs, etc.; entities in a core network such as a UPF), UEs, and/or XR devices may facilitate service data flows from application servers to UEs/XR devices for XR applications. UEs may be, may comprise, and/or may be paired with XR devices to provide user experiences through XR. Wireless communication networks, such as 5G NR among others, may provide a high-speed, low-latency and high-reliability wireless connectivity which can enable latency-sensitive services like the immersive XR multimedia and cloud computing (e.g., AR Glasses, a VR HMD, haptic gloves/other tactile equipment, cloud gaming, cloud AI, and/or the like). In some scenarios, dual-modalities for an XR experience may be used, such as for both video and haptic modalities. Such advanced applications may have high levels for operational/system performance parameters to maintain the user experience, including but without limitation, data rate, latency, power consumption, and/or the like (e.g., a stipulated PDB of 10 ms for XR traffic packets to maintain the user experience). However, support of DC scenarios in NR, and beyond, introduce issues that are not accounted for in the current state of the art. For example, with split bearers, a network node (e.g., a Master Node or a Secondary Node) that receives data from a UPF can transmit the data in the MCG and in the SCG, and if a QoS flow (e.g., for XR) has been configured to carry PDU sets, some of the PDUs can be transmitted in the MCG, while others can be transmitted in the SCG. When a first network node forwards PDUs to a second network node for provision to the UE, current solutions lack mechanisms for the second network node receiving the forwarded PDUs to be aware of information associated with the PSDB/the PSDB expiry time, synchronization thresholds between PDU sets for dual-modalities, end PDU/burst indications, and/or the like. Accordingly, the second network node is unable to efficiently schedule transmission of the forwarded PDUs to the UE, which negatively impacts the XR user experience.

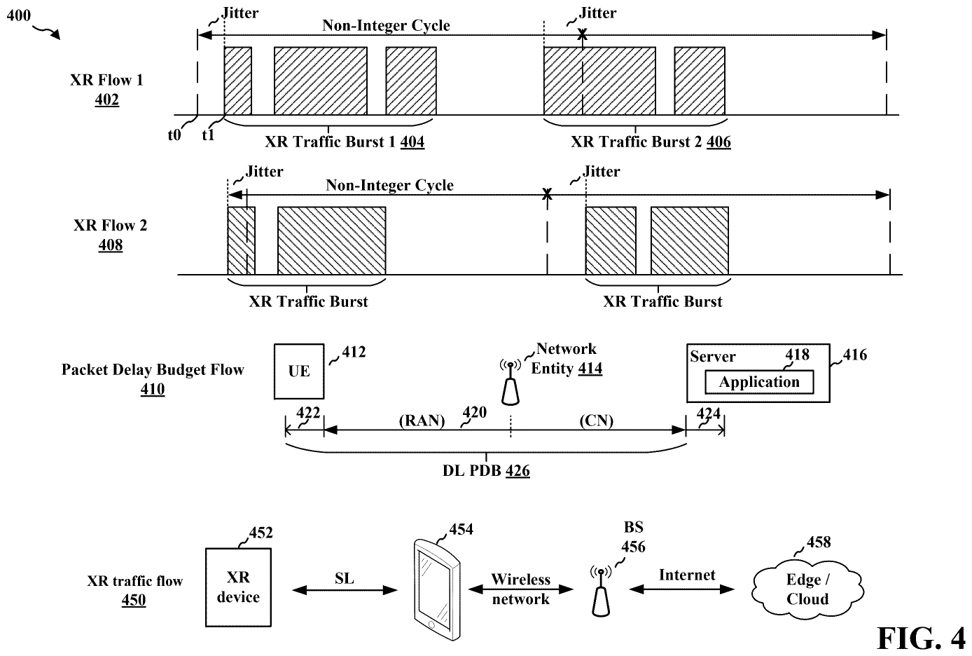

FIG. 4 is a diagram 400 illustrating example XR traffic and an example XR traffic flow. XR traffic may refer to wireless communications for technologies such as virtual reality (VR), mixed reality (MR), and/or augmented reality (AR). VR may refer to technologies in which a user is immersed in a simulated experience that is similar or different from the real world. A user may interact with a VR system through a VR headset, a multi-projected environment that generates realistic images, sounds, and other sensations that simulate a user's physical presence in a virtual environment, and/or the like. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In an example, an AR system may overlay sensory information (e.g., images) onto a natural environment and/or mask real objects from the natural environment. XR traffic may include video data and/or audio data. XR traffic may be transmitted by a base station and received by a UE or the XR traffic may be transmitted by a UE and received by a base station. XR traffic may arrive in periodic traffic bursts (“XR traffic bursts”). An XR traffic burst may vary in a number of packets per burst and/or a size of each pack in the burst. The diagram 400 illustrates a first XR flow 402 that includes a first XR traffic burst 404 and a second XR traffic burst 406. As illustrated in the diagram 400, the traffic bursts may include different numbers of packets, e.g., the first XR traffic burst 404 being shown with three packets (represented as rectangles in the diagram 400) and the second XR traffic burst 406 being shown with two packets. Furthermore, as illustrated in the diagram 400, the three packets in the first XR traffic burst 404 and the two packets in the second XR traffic burst 406 may vary in size, that is, packets within the first XR traffic burst 404 and the second XR traffic burst 406 may include varying amounts of data.

XR traffic bursts may arrive at non-integer periods (i.e., in a non-integer cycle). The periods may be different than an integer number of symbols, slots, etc. In an example, for 60 frames per second (FPS) video data, XR traffic bursts may arrive in 1/60=16.67 ms periods. In another example, for 120 FPS video data, XR traffic bursts may arrive in 1/120=8.33 ms periods.

Arrival times of XR traffic may vary. For example, XR traffic bursts may arrive and be available for transmission at a time that is earlier or later than a time at which a UE (or a base station) expects the XR traffic bursts. The variability of the packet arrival relative to the period (e.g., 16.76 ms period, 8.33 ms period, etc.) may be referred to as “jitter.” In an example, jitter for XR traffic may range from −4 ms (earlier than expected arrival) to +4 ms (later than expected arrival). For instance, referring to the first XR flow 402, a UE may expect a first packet of the first XR traffic burst 404 to arrive at time to, but the first packet of the first XR traffic burst 404 arrives at a time t1, as shown.

XR traffic may include multiple flows that arrive at a UE (or a base station) concurrently with one another (or within a threshold period of time). For instance, the diagram 400 includes a second XR flow 408. The second XR flow 408 may have different characteristics than the first XR flow 402. For instance, the second XR flow 408 may have XR traffic bursts with different numbers of packets, different sizes of packets, etc. In an example, the first XR flow 402 may include video data and the second XR flow 408 may include audio data for the video data. In another example, the first XR flow 402 may include intra-coded picture frames (I-frames) that include complete images and the second XR flow 408 may include predicted picture frames (P-frames) that include changes from a previous image.

As noted herein, XR traffic may have an associated e2e PDB. If a packet does not arrive within the e2e PDB, a UE (or a base station) may discard the packet. In an example, if a packet corresponding to a video frame of a video does not arrive at a UE within an e2e PDB, the UE may discard the packet, as the video has advanced beyond the frame.

An XR traffic overall PDB may include a portion to allow for communication delay of data (e2e PDB) between a UE and a computing device, e.g., a server, hosting an application, e.g., for XR, and a portion for additional time after the communication delay before the data is discarded, e.g., residual delay (e.g., RDB). For instance, the diagram 400 includes a packet delay budget flow 410. Packet delay budget flow 410 illustrates a UE 412, a network entity 414 (e.g., a base station or portion thereof), and a server 416 that hosts an application 418. In the illustrated aspect, a communication delay 420 is shown as including a RAN portion between the UE 412 and the network entity 414, as well as a CN portion between the network entity 414 and the server 416. The communication delay 420 may apply to both UL and DL communications. Additionally, a residual delay 422 is shown at the UE 412 for DL communications and a residual delay 424 is shown at the server 416 for UL communications. The communication delay 420 and the residual delay 422 may make up an overall PDB for DL XR communications, e.g., DL PDB 426. Likewise, the communication delay 420 and the residual delay 424 may make up an overall PDB for UL XR communications (not shown for illustrative clarity).

In general, XR traffic may be characterized by relatively high data rates and low latency. The latency in XR traffic may affect the user experience. For instance, XR traffic may have applications in eMBB and URLLC services.

An example of an XR traffic flow 450 is also shown in the context of an XR implementation between an XR device 452 (e.g., a SL Rx UE) and a companion UE 454 (e.g., a smartphone as a SL Tx UE), where the companion UE 454 communicates over a wireless network with a network node (e.g., a base station 456, a gNB, etc.). The base station 456 may communicate with an edge/cloud server 458 that hosts an XR application with which the XR device 452 may be associated.

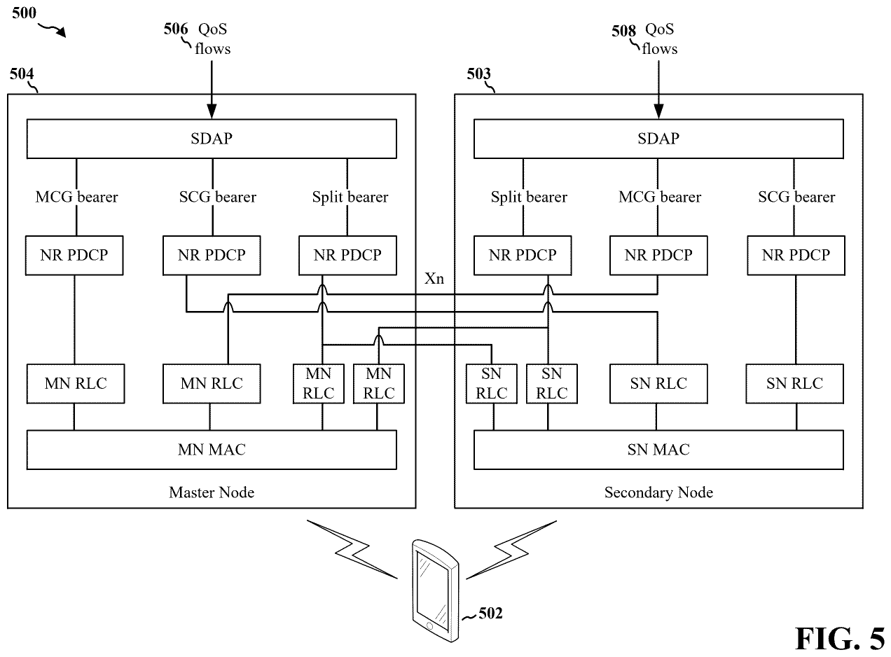

FIG. 5 is a diagram 500 illustrating example network side protocols in DC. Diagram 500 shows a first and a second network node (e.g., as a master node (MN) 504 and a secondary node (SN) 503) in the context of DC for wireless communications with a UE 502. With split bearers, the first node (the MN 504 or the SN 503) that receives data from a UPF (e.g., a QoS flow 506, a QoS flow 508) can transmit the data in the MCG and/or in the SCG. If the QoS flow 506/the QoS flow 508 has been configured to carry PDU sets, some of the PDUs of a PDU set can be transmitted in the MCG for the UE 502, while others can be transmitted in the SCG for the UE 502.

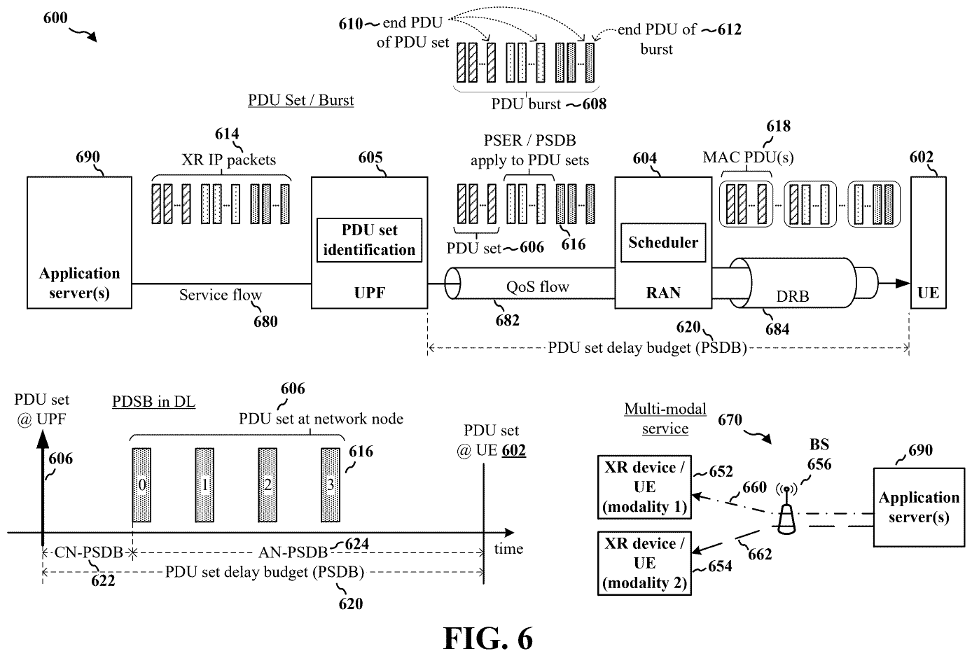

FIG. 6 is a diagram 600 illustrating an example PSDB and multi-modal service. Diagram 600 illustrates a PSDB 620 in the context of a service flow 680 and a multi-modal service 670 in the context of a first modal flow 660 and a second modal flow 662.

The PSDB 620 may include a CN-PSDB portion 622 associated with delay in the core network and an AN-PSDB portion 624 associated with delay in the RAN. The PSDB 620 may define an upper bound for the delay that a PDU set(s) 606 may experience for the transfer between the UE 602 and the N6 termination point at a UPF 605 (e.g., in downlink: a duration between the reception time of the first PDU at the UPF 605 and the time when all PDUs of the PDU set(s) 606 have been successfully received at the UE 602; in uplink: a duration between the reception time of the first PDU at the UE 602 and the time when all PDUs of the PDU set(s) 606 have been successfully received at the UPF 605).

An application server 690 may provide the service flow 680 to a UPF 605 as XR IP packets 614. The UPF 605 may perform PDU set identification for the XR IP packets 614 to generate the PDU set(s) 606 comprising one or more PDUs 616. The PDU set(s) 606 may comprise a PDU burst 608 (e.g. a data burst); each PDU set may have an end PDU 610 of the PDU set, and each PDU burst may have an end PDU 612 of the PDU burst. The PDU set(s) 606/the PDU burst 608 at the UPF enters a QoS flow 682 for the service flow 680 in which the PSDB 620 is entered. The RAN 604 receives the PDU set(s) 606 and a scheduler schedules provision of the PDU set(s) 606, e.g., via MAC PDU(s) 618, for the UE 602 over a data radio bearer (DRB) 684.

Regarding, immersive multi-modal VR/XR applications, e.g., with multiple 5G UEs such as an XR device/UE 652 and an XR device/UE 654, tactile and multi-modal communication services from the application server(s) 690 via a base station 656 may enable multi-modal interactions, combining ultra-low latency with extremely high availability, reliability, and security. For a good, immersive experience, data from multi-modal flows (e.g., visual-tactile, audio-tactile, etc.) such as the first modal flow 660 and the second modal flow 662 should be received by UEs (e.g., the XR device/UE 652 and the XR device/UE 654) within synchronization thresholds. For example, in an audio-tactile scenario, synchronization thresholds may be 50 ms for audio delay and 25 ms for tactile delay; in a visual-tactile scenario, synchronization thresholds may be 15 ms for visual delay and 50 ms for tactile delay.

Aspects herein provide for signaling to communicate deadlines to transmit packets between network elements. Aspects herein for DC for XR communications improve such issues. Aspects enable a first network node to inform the second network node of a PDU set expiry time for efficient UE transmission scheduling of first subsets of PDUs in DC by providing PDU set information, associated with forwarded first subsets of PDUs for PDU sets to a second network node, as well as information about the PSDB expiry. Aspects enable management of synchronization threshold times in DC by providing associated PDU sets to a UE via a single network node or providing delivery time information for forwarded PDUs from a second to a first network node. Aspects enable enhancements for RRM and scheduling policies for the second network node by providing information associated with end PDUs of PDU sets/bursts from a first network node to a second network node. Aspects here may relate to/be implemented for any multi-RAT DC scenario, such as but not limited to, NR-DC, E-UTRA-NR DC (EN-DC), NR-E-UTRA DC (NE-DC), and/or the like.

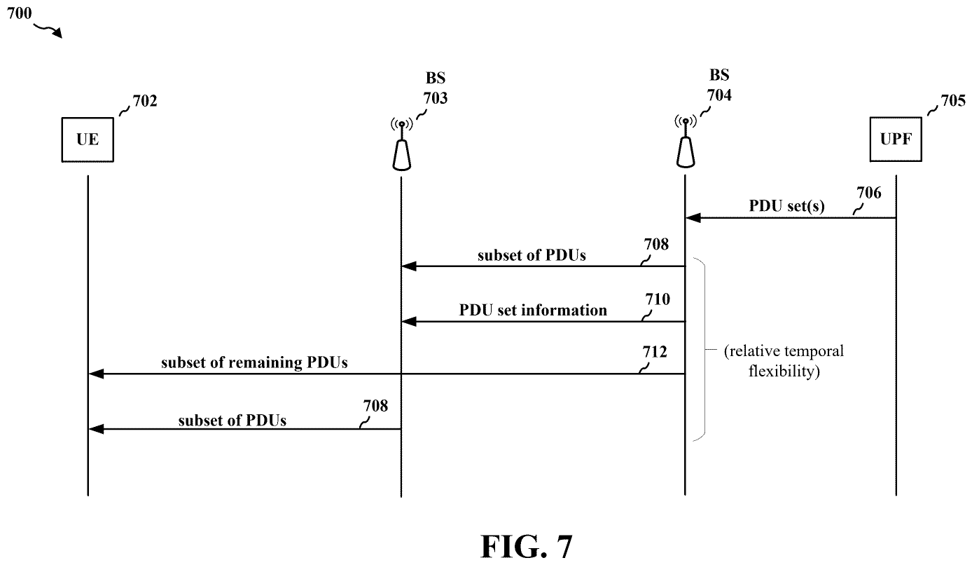

FIG. 7 is a call flow diagram 700 for wireless communications, in various aspects. Call flow diagram 700 illustrates to DC for XR communications of a first network node (e.g., a base station 704, a gNB, etc., as shown and described herein) and a second network node (e.g., a base station 703, a gNB, etc., as shown and described herein) with a UE 702 (e.g., an XR device(s)), by way of example. The UE 702 may communicate via sidelink (SL) connections with an XR device(s) and/or may be/comprise an XR device(s) for utilization of XR applications, in aspects. Aspects described for base stations, and for network nodes/entities herein, generally, may be performed in aggregated form and/or by one or more components in disaggregated form.

In aspects, the base station 704 (e.g., as a first network node) may be configured to receive, and the UPF 705 may be configured to transmit/provide, at least one PDU set 706 for a UE 702 that is configured for DC with the base station 704 and the second base station 703 (e.g., as a second network node). In aspects, each PDU set of the at least one PDU set 706 may include one or more PDUs.

In aspects, the base station 704 (e.g., the first network node) may be configured to provide at least one of (i) a first subset of PDUs 708 for each PDU set of the at least one PDU set 706 and PDU set information 710 respectively associated with the first subset of PDUs 708 for each PDU set to the base station 703 (e.g., the second network node), or (ii) a second subset of remaining PDUs 712 for each PDU set to the UE 702. In aspects, the base station 703 (e.g., the second network node) may be configured to receive, from the base station 704 (e.g., the first network node) and associated with at least one PDU set 706 for the UE 702 that is configured for DC with the base station 704 and the base station 703 (e.g., the first network node and the second network node), the first subset of PDUs 708 for each PDU set of the at least one PDU set 706 and the PDU set information 710 respectively associated with the first subset of PDUs 708 for each PDU set. In aspects, each PDU set includes one or more PDUs.

In aspects, the PDU set information 710 may include an indication of a PSDB for an associated PDU set and a PSDB expiry time. In aspects, the indication of the PSDB expiry time may be based on at least one of a time remaining until the PSDB expiry time or a network time corresponding to the PSDB expiry time. In aspects, the indication of the PSDB may be/comprise an indication indicative of an occurrence of the PSDB expiry time. The time remaining until the PSDB expiry time may be associated with a first time difference between (i) the PSDB and (ii) a second time difference between a provision time of the first subset of PDUs 708 of the associated PDU set and an arrival time of an initial PDU of the associated PDU set. In some aspects, the network time corresponding to the PSDB expiry time may be based on at least one of a radio frame number or a slot number within a radio frame associated with the radio frame number.

In some aspects, the at least one PDU set 706 may be multi-modal (e.g., visual-haptic, audio-haptic, etc.) and may include a first PDU set associated with a first service and a second PDU set associated with a second service that is different from the first service. In such aspects, to provide the first subset of PDUs 708 for each PDU set to the base station 703 (e.g., the second network node), the base station 704 (e.g., the first network node) may be configured to provide, to the base station 703 and in association with a synchronization threshold time for the first PDU set, the first PDU set associated with the first service and the second PDU set associated with the second service. The PDU set information 710 may include an indication of the synchronization threshold time for the first PDU set. In some aspects, to provide the second subset of remaining PDUs 712 for each PDU set to the UE 702, the base station 704 may be configured to provide, to the UE 702 and in accordance with the synchronization threshold time for the first PDU set, the first PDU set associated with the first service and the second PDU set associated with the second service.

In aspects, the base station 704 (e.g., the first network node) may be configured to receive, and the base station 703 (e.g., the second network node) may be configured to transmit/provide, for each PDU of the first subset of PDUs 708, delivery time information indicative of a delivery time of the PDU to the UE 702. In such aspects, the base station 704 and/or the base station 703 may be configured to determine whether each PDU of the first subset of PDUs 708 has met a synchronization threshold time based on the delivery time information. In some aspects, the delivery time information may indicate at least one of a radio frame number, a slot number within a radio frame associated with the radio frame number, or a time difference between the delivery time of the PDU to the UE 702 and a provision time of the PDU to the base station 703 (e.g., the second network node). In such aspects, to receive the delivery time information, the base station 704 (e.g., the first network node) may be configured to receive the delivery time information in a downlink data delivery status frame from the base station 703 (e.g., the second network node).

The PDU set information 710 may include an indication of a synchronization threshold time for the first PDU set and a threshold expiry time of the synchronization threshold time. Accordingly, to provide the PDU set information 710, the base station 704 may be configured to provide the PDU set information 710 per PDU set or per PDU. In some aspects, the indication of the threshold expiry time may be based on at least one of a time remaining until the threshold expiry time or a network time corresponding to the threshold expiry time. In some aspects, the indication of the synchronization threshold time may be indicative of an occurrence of the threshold expiry time. The time remaining until the threshold expiry time may be associated with a first time difference between (i) the synchronization threshold time and (ii) a second time difference between a provision time of the first subset of PDUs 708 of the associated PDU set and a delivery time of the associated PDU set to the UE 702. In some aspects, the network time corresponding to the threshold expiry time may be based on at least one of a radio frame number or a slot number within a radio frame associated with the radio frame number.

In some aspects, the first subset of PDUs 708 may include, based on the first subset of PDUs 708 having at least one PDU other than an end PDU, at least one of (i) the end PDU for each PDU set, or (ii) an indication of termination of PDU provision, for each PDU set, to the base station 703 (e.g., the second network node). The end PDU may include a header bit/indication indicative of a transmission for the end PDU from the base station 703 (e.g., the second network node), and the second subset of remaining PDUs 712 may further include the end PDU in association with a value of the header bit/indication. In some aspects, the indication of termination of PDU provision may be included in a downlink user data frame. The end PDU may be also a burst end PDU of a PDU burst. In such aspects, the PDU burst may comprise each PDU set of the at least one PDU set 706, and the indication of termination of PDU provision may be indicative of the termination of PDU provision for the PDU burst. As noted, the base station 704 (e.g., the first network node) may be configured to provide a second subset of remaining PDUs 712 for each PDU set to the UE 702. The base station 703 may be configured to provide/transmit, for the UE 702 and in accordance with an indication of the PSDB for an associated PDU set and a PSDB expiry time for the PDU set information 710, the first subset of PDUs 708 for each PDU set of the at least one PDU set 706.

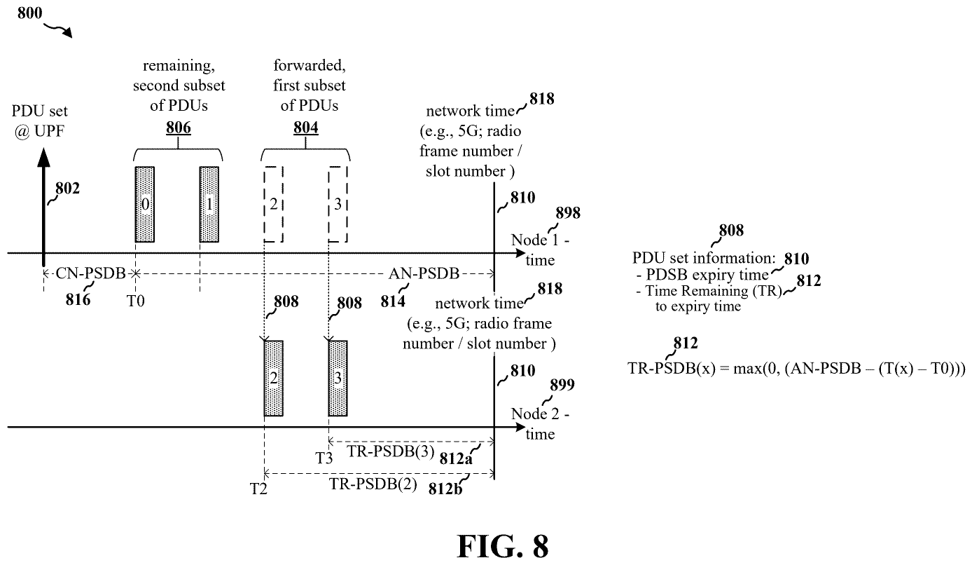

FIG. 8 is a diagram 800 illustrating an example PSDB with PDU set information for DC, in various aspects. Diagram 800 shows interactions between a first network node 898 and a second network node 899 for provision of a PDU set 802 to a UE.

Regarding PSDB and synchronization thresholds in DC, Some PDUs of the PDU set 802, which are received by one of the network nodes (e.g., the first network node 898), may be forwarded to the other network node (e.g., the second network node 899). In the current state of the art, the second network node 899 may lack knowledge about when the PSDB of the PDU set 802 expires, and about when the synchronization threshold of PDU sets that belong to the same multi-modal service expires. The second network node 899 may not be able to schedule efficiently for the transmissions of the PDUs being forwarded thereto, and the user experience may be impacted.

In the illustrated aspect for diagram 800, the PDU set 802 may be subject to a PSDB that includes portions: a CN-PSDB 816 and an AN-PSDB 814. The first network node 898 may forward a first subset of PDUs 804 (e.g., PDUs 2, 3) to the second network node 899 for provision to the UE from the second network node 899, and may schedule a second subset of remaining PDUs 806 for provision to the UE from the first network node 898.

In some aspects, to address the two issues noted above, and for an efficient transmission of the forwarded, first subset of PDUs 804 of the PDU set 802, the second network node 899 may be made aware of when the PSDB of the PDU set 802 is going to expire. As an example, for any PDU Set which is fully or partly forwarded to the second network node 899, the first network node 898 may be configured to provide information about the PSDB expiry, e.g., PDU set information 808. In aspects, the PDU set information 808 may be/include the time remaining (TR) 812 until expiry time when the PSDB expires, PDSB expiry time 810 (e.g., a network time 818 such as a 5G NR time when the PSDB expires), etc. In aspects, for any given PDU ‘x’ which is forwarded by the first network node to the second network node, the TR 812 until the PSDB expires (shows as TR_PSDB (x)) may be calculated as:

$$TR - PSDB ( x ) = max ( 0 , ( AN - PSDB - ( T ( x ) - T 0 ) ) ,$$

where AN-PSDB is the AN-PSDB 814, where TO is the arrival time of the first PDU of the PDU set 802, and T(x) is the time when the first network node forwards the PDU ‘x’ to the second network node.

As examples for the PDUs of the forwarded first subset of PDUs 804, a TR-PSDB (2) 812a for the PDU 2 may be based on time T2 and a TR-PSDB (3) 812b for the PDU 3 may be based on time T3, as shown.

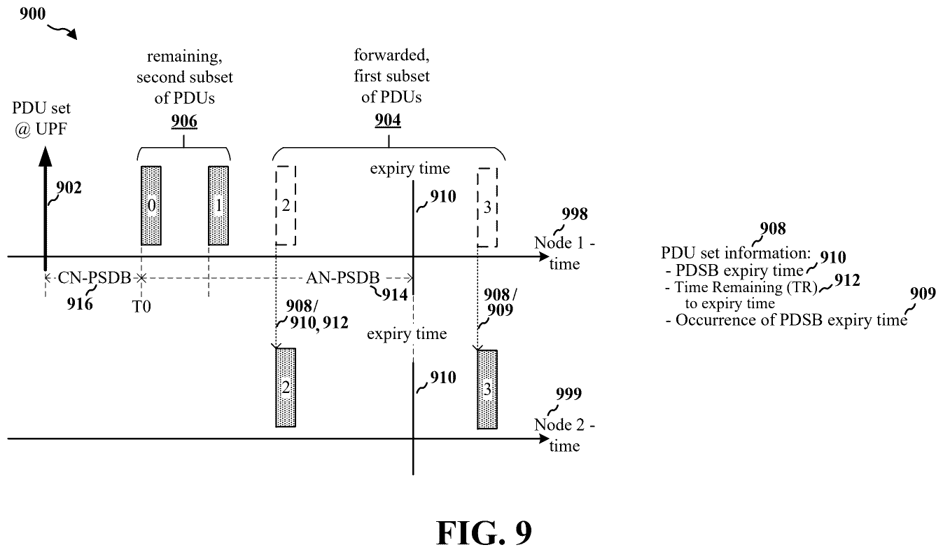

FIG. 9 is a diagram 900 illustrating an example occurrence of a PSDB expiry time and PDU set information for DC, in various aspects. Diagram 900 shows interactions between a first network node 998 and a second network node 999 for provision of a PDU set 902 to a UE. Diagram 900 may be an aspect of diagram 800 in FIG. 8.

Regarding PSDB and synchronization thresholds in DC, Some PDUs of the PDU set 902, which are received by one of the network nodes (e.g., the first network node 998), may be forwarded to the other network node (e.g., the second network node 999). In the current state of the art, the second network node 999 may lack knowledge about when the PSDB of the PDU set 902 expires, and about when the synchronization threshold of PDU sets that belong to the same multi-modal service expires. The second network node 999 may not be able to schedule efficiently for the transmissions of the PDUs being forwarded thereto, and the user experience may be impacted. In the illustrated aspect for diagram 900, the PDU set 902 may be subject to a PSDB that includes a CN-PSDB portion 916 and an AN-PSDB portion 914. The first network node 998 may forward a first subset of PDUs 904 (e.g., PDUs 2, 3) to the second network node 999 for provision to the UE from the second network node 999, and may schedule a second subset of remaining PDUs 906 for provision to the UE from the first network node 998.

In some aspects, to address the issues noted above, and for an efficient transmission of the forwarded, first subset of PDUs 904 of the PDU set 902, the second network node 999 may be made aware of when the PSDB of the PDU set 902 is going to expire/has already expired. As an example, for any PDU Set which is fully or partly forwarded to the second network node 999, the first network node 998 may be configured to provide information about the PSDB expiry, e.g., PDU set information 908. In aspects, the PDU set information 908 may be/include the time remaining (TR) 912 until expiry time when the PSDB expires, PDSB expiry time 810 (e.g., a network time such as a 5G NR time when the PSDB expires), etc., as described herein. In aspects, the PDU set information 908 may be/include an indication 909 of an occurrence of the PDSB expiry time 910. For instance, a special value of the PDU set information 908/the PSDB expiry time 910 may comprise the indication 909 of the occurrence of the PDSB expiry time 910 (e.g., may indicate that the PSDB has already expired). In aspects, the second network node 999 may utilize knowledge of such an expiration for PDUs (e.g., PDU 3) which are forwarded (as the first subset of PDUs 904) after the PSDB of their PDU set 902 has expired at the expiry time 910.

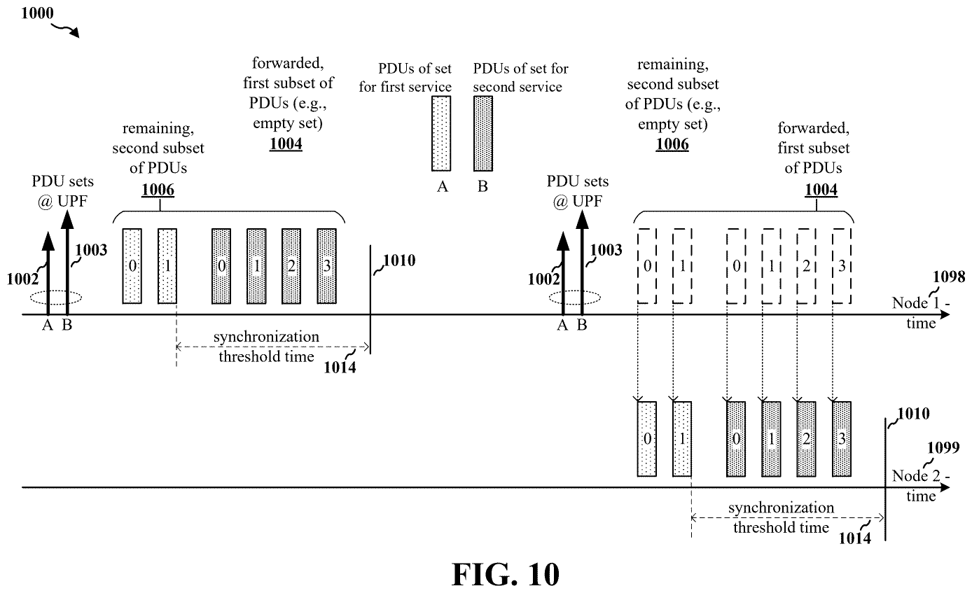

FIG. 10 is a diagram 1000 illustrating an example of synchronization threshold management in multi-modal flows for DC, in various aspects. Diagram 1000 shows interactions between a first network node 1098 and a second network node 1099 for provision of a PDU set 1002 for a first modality A and a PDU set 1003 for a second modality B to a UE.

Regarding synchronization threshold management in DC, with multi-modal flows, a synchronization threshold time 1014 (e.g., as a timer) may be started when the PDU set from either flow is delivered successfully. For example, assuming two QoS flows (A, B) for the first modality A and the second modality B, respectively, and the two PDU sets (e.g., the PDU set 1002 and the PDU set 1003, which belong to QoS Flows A and B respectively, where the PDU set 1002 is delivered first, issues may arise in the current state of the art. For example, as the first network node 1098 may forward some PDUs of the PDU set 1002 to the second network node 1099, the first network node 1098 may lack knowledge of when all PDUs of the PDU set 1002 have been delivered successfully by the second network node 1099. Additionally, when the PDU set 1002 is delivered, the synchronization threshold time 1014 kicks in, and likewise with the PSDB expiry, second network node 1099 may lack knowledge about when this threshold expires. Aspects herein provide solutions to such issues. In some aspects, it may be inferred that the two QoS Flows of the same multi-modal service terminate at the same node.

In some aspects, to address the issues noted above, each/all PDUs of associated the PDU sets (e.g., the PDU set 1002, the PDU set 1003) go through the same path: either the MCG or the SCG. In other words, each PDU of both of these PDU sets may be provided by the first network node 1098 (e.g., all PDUs as a second subset of remaining PDUs 1006 and an empty set for a forwarded, first set of PDUs 1004), or may be provided by the second network node 1099 (e.g., all PDUs as the first set of PDUs 1004 and an empty set for the second subset of remaining PDUs 1006). Put another way, the first network node 1098 (e.g., where the QoS flows of the same multi-modal service terminate), may be configured to either transmit all PDUs of associated PDU sets, or to forward all PDUs of associated PDU sets to the second network node 1099. In this way, the node from which all the PDUs of both PDU sets is provided to the UE has full knowledge of the PDUs for both modalities and can thus schedule provision to the UE in accordance with the synchronization threshold time 1014 and its associated threshold expiry time 1010.

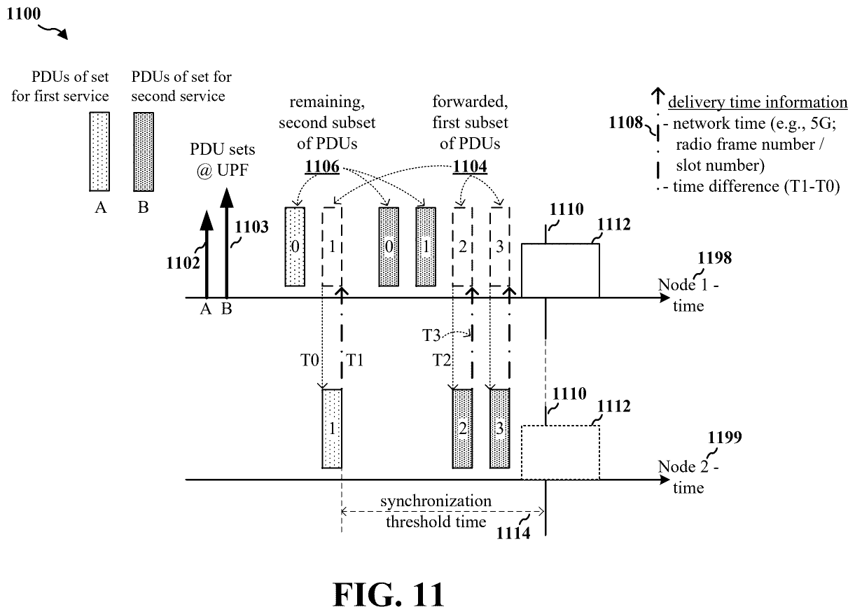

FIG. 11 is a diagram 1100 illustrating an example of synchronization threshold management in multi-modal flows for DC, in various aspects. Diagram 1100 shows interactions between a first network node 1198 and a second network node 1199 for provision of a PDU set 1102 for a first modality A and a PDU set 1103 for a second modality B to a UE.

Regarding synchronization threshold management in DC, with multi-modal flows, a synchronization threshold/timer 1114 may be started when the PDU set from either flow is delivered successfully. For example, assuming two QoS flows (A, B) for the first modality A and the second modality B, respectively, and the two PDU sets (e.g., the PDU set 1102 and the PDU set 1103, which belong to QoS Flows A and B respectively, where the PDU set 1102 is delivered first, issues may arise in the current state of the art. For example, as the first network node 1198 may forward some PDUs of the PDU set 1102 to the second network node 1199, the first network node 1198 may lack knowledge of when all PDUs of the PDU set 1102 have been delivered successfully by the second network node 1199. Additionally, when the PDU set 1102 is delivered, the synchronization threshold/timer 1114 kicks in, and likewise with the PSDB expiry, the second network node 1199 may lack knowledge about when the synchronization threshold/timer 1114 expires at its threshold expiry time 1110. Aspects herein provide solutions to such issues. In some aspects, it may be inferred that the two QoS Flows of the same multi-modal service terminate at the same node. In some aspects, to address the issues noted above, such as when the aspects described for FIG. 10 may not be/are not implemented, the second network node 1199 may inform the first network node 1098 of the provision of PDUs forwarded to the second network node 1099 in a first subset of PDUs 1104.

For example, the first network node 1198 may be configured to schedule the second subset of remaining PDUs 1106 for provision to the UE, while the first subset of PDUs 1104, including a PDU from the PDU set 1102 for the first modality A (transmitted first), is forwarded to the second network node 1199. In aspects, for each PDU from a PDU set that the second network node 1099 receives from the first network node 1098, the second network node 1199 may be configured to signal/transmit/provide delivery time information 1108 to the first network node 1098 when a given PDU was delivered to the UE. Accordingly, the first network node 1098 and/or the second network node 1199 may be configured to determine (at 1112) whether each PDU of the first subset of PDUs 1104 has met the synchronization threshold time 1114 (for its threshold expiry time 1110) based on the delivery time information 1108. In aspects, the delivery time information 1108 reported by the second network node 1199 for a given PDU ‘x’ may be at least one of: the network/5G time (e.g., a Radio Frame Number and/or a Slot Number) and/or a time difference (e.g., T1-T0, T3-T2, etc.) from the reception of the PDU from the first network node 1198 (T0) to the successful delivery to the UE. Based on such information, the first network node 1198 may be configured to determine/figure out when the synchronization threshold time 1114 kicks in and subsequently the threshold expiry time 1110. In aspects, the delivery time information 1108 may be provided by the second network node 1199 to the first network node 1098 in a DL DATA DELIVERY STATUS frame.

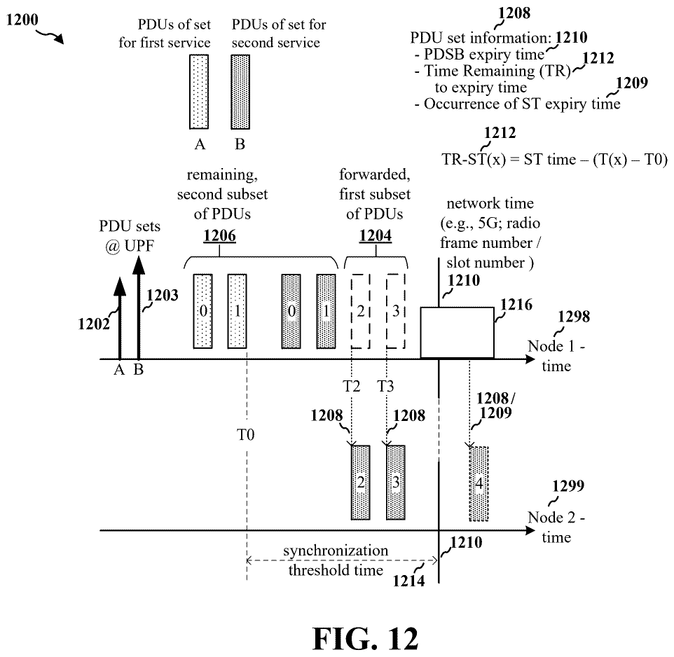

FIG. 12 is a diagram 1200 illustrating an example of synchronization threshold management in multi-modal flows for DC, in various aspects. Diagram 1200 shows interactions between a first network node 1298 and a second network node 1299 for provision of a PDU set 1202 for a first modality A and a PDU set 1203 for a second modality B to a UE.

Regarding synchronization threshold (ST) management in DC, with multi-modal flows, a synchronization threshold time 1214 (e.g., as a timer) may be started when the PDU set from either QoS flow is delivered successfully. For example, assuming two QoS flows (A, B) for the first modality A and the second modality B, respectively, and the two PDU sets (e.g., the PDU set 1202 and the PDU set 1203, which belong to QoS Flows A and B respectively, where the PDU set 1202 is delivered first, issues may arise in the current state of the art. For example, as the first network node 1298 may forward some PDUs of the PDU set 1202 to the second network node 1299, the first network node 1298 may lack knowledge of when all PDUs of the PDU set 1202 have been delivered successfully by the second network node 1299. Additionally, when the PDU set 1202 is delivered, the synchronization threshold time 1214 kicks in, and likewise with the PSDB expiry, the second network node 1299 may lack knowledge about when this threshold expires. Aspects herein provide solutions to such issues. In some aspects, it may be inferred that the two QoS Flows of the same multi-modal service terminate at the same node.

In some aspects, to address the issues noted above for the second network node 1299 lacking knowledge about when the synchronization threshold time 1214 expires at its threshold expiry time 1210, such as when the aspects described for FIGS. 10, 11 may not be/are not implemented, the aspects described above for PSDB expiry (e.g., for FIGS. 8, 9) may be extensible for synchronization threshold time management, initiation, and expiry.

For example, if the first network node 1298 has determined a synchronization threshold time 1214 for a PDU set (e.g., the PDU set 1202, the PDU set 1203) based on provision of the PDU set 1202 in the second set of remaining PDUs 1206, the first network node 1298 may be configured to provide the second network node 1299 with PDU set information 1208 about a threshold expiry time 1210 for the synchronization threshold time 1214. The PDU set information 1208 may be time remaining (TR) 1212 until the synchronization threshold time 1214 expires and/or may be a network time (e.g., a 5G time) when the synchronization threshold time 1214 expires. In aspects, the PDU set information 1208 may be provided with any or all of the PDUs of the PDU set that is forwarded (e.g., PDUs of the first subset of PDUs 1204). In some aspects, for a given PDU ‘x’, the TR 1212 (TR-ST(x)) until the synchronization threshold time 1214 expires may be calculated as:

$$TR - ST ( x ) = synchronization threshold time - ( T ( x ) - T 0 ) ,$$

where T0 is the time of successful delivery of the first PDU set (the PDU set 1202) for QoS flow A, and where T(x) is the time when the first network node 1298 forwards the PDU ‘x’ from the second PDU set (the PDU set 1203) for QoS flow B to the second network node 1299. In aspects, the network time for the threshold expiry time 1210 may be the system time (e.g., a radio Frame number, a slot number inside the radio frame, etc.) when the synchronization threshold time 1214 expires. Accordingly, the first network node 1298 may be configured to determine (at 1216) whether each forwarded PDU of the first subset of PDUs 1204 (e.g., PDU 2, PDU 3) has met the synchronization threshold time 1214 (for its threshold expiry time 1210) based on the PDU set information 1208.

In aspects, the PDU set information 1208 may be/include an indication 1209 of an occurrence of the synchronization threshold time 1214 and the threshold expiry time 1210. For instance, a special value of the PDU set information 1208/the threshold expiry time 1210 may comprise the indication 1209 of the occurrence of the expiry of the synchronization threshold time 1214 (e.g., may indicate that the synchronization threshold time 1214 has already expired). In aspects, the second network node 1299 may utilize knowledge of such an expiration for PDUs (e.g., a PDU 4) which are forwarded (as the first subset of PDUs 1204) after the P synchronization threshold time 1214 SDB of their PDU set has expired at the threshold expiry time 1210.

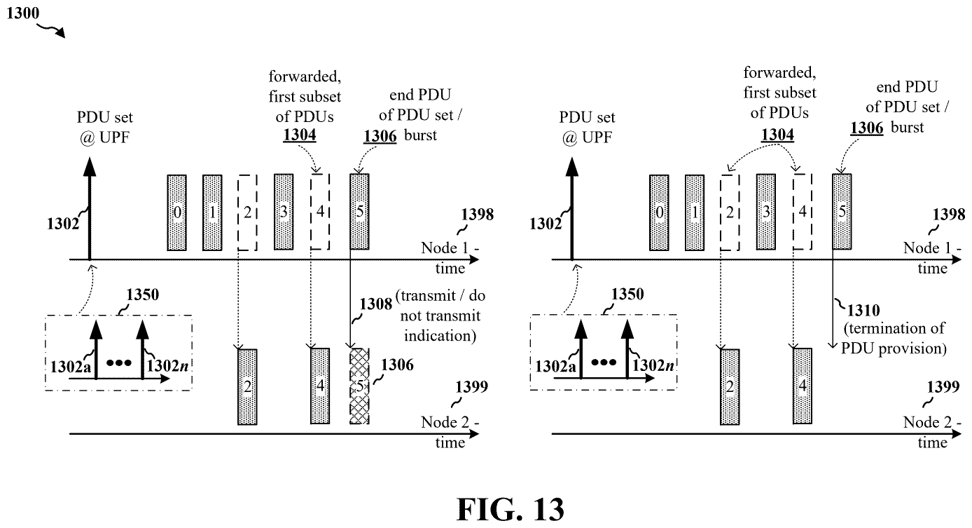

FIG. 13 is a diagram 1300 illustrating examples of PDU set/burst ending management for DC, in various aspects. Diagram 1300 shows interactions between a first network node 1398 and a second network node 1399 for provision of a PDU set 1302/a PDU burst 1350 (e.g., a number of PDU sets from a PDU set 1302a to a PDU set 1302n) to a UE.

Regarding an end PDU 1306 of the PDU set 1302 (which may comprise the PDU burst 1350) in DC, some PDUs (e.g., PDU 2, PDU 4) of the PDU set 1302 which are received by one of the nodes (the first network node 1398) can be forwarded to the other node (the second network node 1399). With the current state of the art, if the end PDU 1306 of the PDU set 1302/the PDU set 1302n of the PDU burst 1350 is not forwarded to the second network node 1399, the second network node 1399 has no knowledge that no more PDUs of the PDU set 1302/the PDU burst 1350 are going to be received from the first network node 1398 as part of the first subset of PDUs 1304. Thus, the RRM and scheduling policies of the second network node 1399 can be enhanced if the second network node 1399 is notified that no more PDUs of the PDU set 1302 or the PDU burst 1350 are going to be received from the first network node 1398. As an example, when the first network node 1398 forwards PDU 4 to the second network node 1399, the first network node 1398 may have not yet received PDU 5/the end PDU 1306.

In some aspects, to address the issues noted above, the first network node 1398 may be configured to always forward the end PDU 1306 to the second network node 1399, but if the first network node 1398 transmits the end PDU 1306, the first network node 1398 may be configured to signal an indication 1308 (transmit/do not transmit) to the second network node 1399 that transmission of the end PDU 1306 is desired, or is not desired/to be utilized. In some aspects, the first network node 1398 may be configured to signal an indication 1310 (for termination of PDU provision (PDU set/burst)) to the second network node 1399 that no more PDUs of the PDU set 1302 will be forwarded. For example, if the first network node 1398 has forwarded at least one PDU (e.g., PDU 2, PDU 4) of the PDU set 1302, the first network node 1398 may be configured to forward the end PDU 1306 of the PDU set 1302 to the second network node 1399. In some aspects, a bit in the GTP-U header of the end PDU 1306 may be reserved as the indication 1308 to signal if the second network node 1399 is to transmit the end PDU 1306 or not. As noted, the end PDU 1306 may also be an end of burst PDU (e.g., of the PDU set 1302n)/the PDU burst 1350 and be similarly handled.

In some aspects, if the first network node 1398 has forwarded at least one PDU (e.g., PDU 2, PDU 4) of the PDU set 1302, when the first network node 1398 receives the end PDU 1306 of the PDU set 1302, the first network node 1398 may be configured to signal the indication 1310 to the second network node 1399 that no more PDUs of the PDU set 1302 will be received. In aspects, the indication 1310 may be provided/received in a DL USER DATA frame. As noted, the end PDU 1306 may also be an end of burst PDU and be similarly handled.

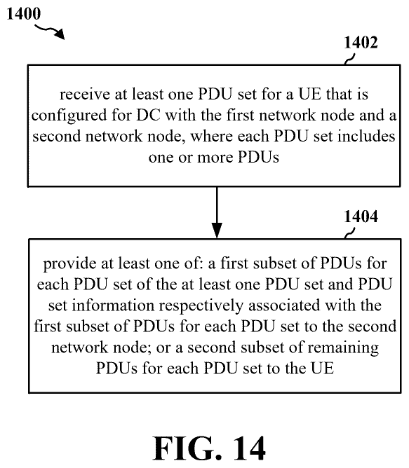

FIG. 14 is a flowchart 1400 of a method of wireless communication. The method may be performed by a first network node/a base station (e.g., the base station 102, 704; the first network node 898, 998, 1098, 1198, 1298, 1398; the network entity 1802, 1902). The method may be for dual connectivity for XR communications. The method may provide for enhanced support of XR with dual connectivity by improving management of PSDBs of PDU sets, synchronization thresholds for multi-modal services, and end PDUs of PDU sets/bursts.

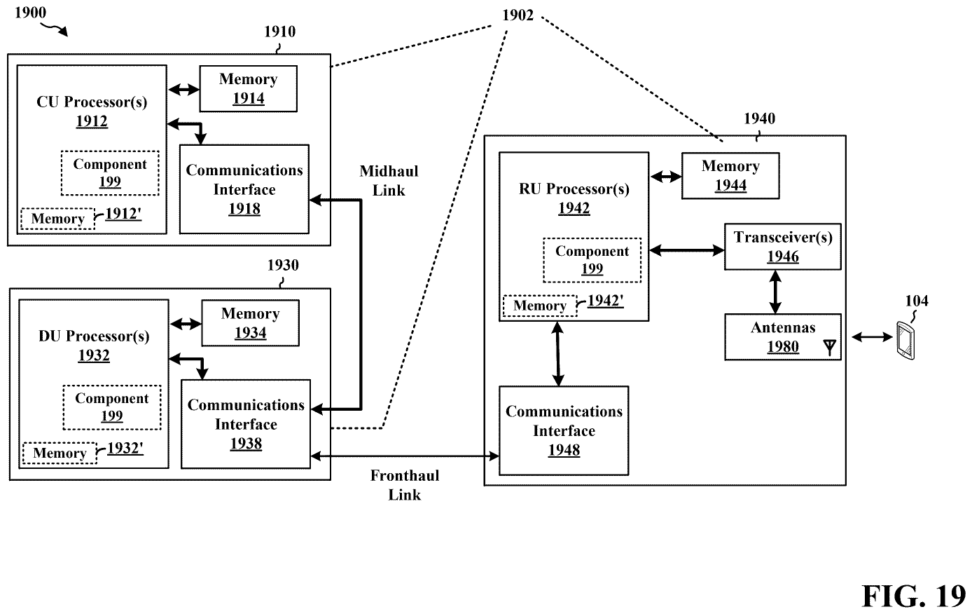

At 1402, the first network node receives at least one PDU set for a UE that is configured for DC with the first network node and a second network node, where each PDU set includes one or more PDUs. As an example, the reception may be performed by one or more of the component 199, the transceiver(s) 1946, and/or the antenna 1980 in FIG. 19. FIG. 7 illustrates, in the context of FIGS. 8-13, an example of a first network node (e.g., the base station 704) receiving such a PDU set(s) from a UPF (e.g., the UPF 705).

In aspects, the base station 704 (e.g., as a first network node) may be configured to receive, and the UPF 705 may be configured to transmit/provide, at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13) for a UE 702 that is configured for DC with the base station 704 and the second base station 703 (e.g., as a second network node). In aspects, each PDU set of the at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13) may include one or more PDUs (e.g., 804, 806 in FIG. 8; 904, 906 in FIG. 9; 1004, 1006 in FIG. 10; 1104, 1106 in FIG. 11; 1204, 1206 in FIG. 12; 1304, 1306 in FIG. 13).

At 1404, the first network node provides at least one of: a first subset of PDUs for each PDU set of the at least one PDU set and PDU set information respectively associated with the first subset of PDUs for each PDU set to the second network node, or a second subset of remaining PDUs for each PDU set to the UE. As an example, the provision may be performed by one or more of the component 199, the transceiver(s) 1946, and/or the antenna 1980 in FIG. 19. FIG. 7 illustrates, in the context of FIGS. 8-13, an example of a first network node (e.g., the base station 704) providing such a first subset of PDUs for a second network node (e.g., the base station 703) and/or providing such second subset of remaining PDUs for a UE (e.g., the UE 702).

In aspects, the base station 704 (e.g., the first network node) may be configured to provide at least one of (i) a first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) for each PDU set of the at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13) and PDU set information 710 (e.g., 808 in FIG. 8; 908 in FIG. 9; 1208 in FIG. 12) respectively associated with the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) for each PDU set to the base station 703 (e.g., the second network node), or (ii) a second subset of remaining PDUs 712 (e.g., 806 in FIG. 8; 906 in FIG. 9; 1006 in FIG. 10; 1106 in FIG. 11; 1206 in FIG. 12) for each PDU set to the UE 702. In aspects, the base station 703 (e.g., the second network node) may be configured to receive, from the base station 704 (e.g., the first network node) and associated with at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13) for the UE 702 that is configured for DC with the base station 704 and the base station 703 (e.g., the first network node and the second network node), the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) for each PDU set of the at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13) and the PDU set information 710 (e.g., 808 in FIG. 8; 908 in FIG. 9; 1208 in FIG. 12) respectively associated with the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) for each PDU set. In aspects, each PDU set includes one or more PDUs (e.g., 804, 806 in FIG. 8; 904, 906 in FIG. 9; 1004, 1006 in FIG. 10; 1104, 1106 in FIG. 11; 1204, 1206 in FIG. 12; 1304, 1306 in FIG. 13). In aspects, the PDU set information 710 (e.g., 808 in FIG. 8; 908 in FIG. 9; 1208 in FIG. 12) may include an indication of a PSDB for an associated PDU set and a PSDB expiry time (e.g., 810 in FIG. 8; 910 in FIG. 9). In aspects, the indication of the PSDB expiry time (e.g., 810 in FIG. 8; 910 in FIG. 9) may be based on at least one of a time remaining (e.g., 812 in FIG. 8; 912 in FIG. 9; 1212 in FIG. 12) until the PSDB expiry time (e.g., 810 in FIG. 8; 910 in FIG. 9) or a network time (e.g., 818 in FIG. 8) corresponding to the PSDB expiry time (e.g., 810 in FIG. 8; 910 in FIG. 9). In aspects, the indication of the PSDB may be/comprise an indication indicative of an occurrence (e.g., 909 in FIG. 9; 1209 in FIG. 12) of the PSDB expiry time (e.g., 810 in FIG. 8; 910 in FIG. 9). The time remaining (e.g., 812, 812a, 812b in FIG. 8; 912 in FIG. 9; 1212 in FIG. 12) until the PSDB expiry time (e.g., 810 in FIG. 8; 910 in FIG. 9) may be associated with a first time difference between (i) the PSDB (e.g., 814 in FIG. 8; 914 in FIG. 9) and (ii) a second time difference between a provision time (e.g., TO in FIGS. 8, 11) of the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) of the associated PDU set and an arrival time (e.g., T2, T3 in FIG. 8) of an initial PDU of the associated PDU set. In some aspects, the network time (e.g., 818 in FIG. 8, 1210 in FIG. 12) corresponding to the PSDB expiry time (e.g., 810 in FIG. 8; 910 in FIG. 9) may be based on at least one of a radio frame number or a slot number within a radio frame associated with the radio frame number.

In some aspects, the at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13) may be multi-modal (e.g., visual-haptic, audio-haptic, etc.) and may include a first PDU set (e.g., A in FIGS. 10, 11, 12) associated with a first service and a second PDU set (e.g., B in FIGS. 10, 11, 12) associated with a second service that is different from the first service. In such aspects, to provide the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) for each PDU set to the base station 703 (e.g., the second network node), the base station 704 (e.g., the first network node) may be configured to provide, to the base station 703 and in association with a synchronization threshold time (e.g., 1014 in FIG. 10; 1114 in FIG. 11, 1214 in FIG. 12) for the first PDU set (e.g., A in FIGS. 10, 11, 12), the first PDU set (e.g., A in FIGS. 10, 11, 12) associated with the first service and the second PDU set (e.g., B in FIGS. 10, 11, 12) associated with the second service. The PDU set information 710 (e.g., 808 in FIG. 8; 908 in FIG. 9; 1208 in FIG. 12) may include an indication of the synchronization threshold time (e.g., 1014 in FIG. 10; 1114 in FIG. 11, 1214 in FIG. 12) for the first PDU set (e.g., A in FIGS. 10, 11, 12). In some aspects, to provide the second subset of remaining PDUs 712 (e.g., 806 in FIG. 8; 906 in FIG. 9; 1006 in FIG. 10; 1106 in FIG. 11; 1206 in FIG. 12) for each PDU set to the UE 702, the base station 704 may be configured to provide, to the UE 702 and in accordance with the synchronization threshold time (e.g., 1014 in FIG. 10; 1114 in FIG. 11, 1214 in FIG. 12) for the first PDU set (e.g., A in FIGS. 10, 11, 12), the first PDU set (e.g., A in FIGS. 10, 11, 12) associated (e.g., A in FIGS. 10, 11, 12) with the first service and the second PDU set (e.g., B in FIGS. 10, 11, 12) associated with the second service.

In aspects, the base station 704 (e.g., the first network node) may be configured to receive, and the base station 703 (e.g., the second network node) may be configured to transmit/provide, for each PDU of the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13), delivery time information (e.g., 1108 in FIG. 11) indicative of a delivery time (e.g., T1 in FIG. 11) of the PDU to the UE 702. In such aspects, the base station 704 and/or the base station 703 may be configured to determine (e.g., at 1112 in FIG. 11) whether each PDU of the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) has met a synchronization threshold time (e.g., 1014 in FIG. 10; 1114 in FIG. 11, 1214 in FIG. 12) based on the delivery time information (e.g., 1108 in FIG. 11). In some aspects, the delivery time information (e.g., 1108 at T1 in FIG. 11) may indicate at least one of a radio frame number, a slot number within a radio frame associated with the radio frame number, or a time difference between the delivery time (e.g., T1, T3, etc. in FIG. 11) of the PDU to the UE 702 and a provision time (e.g., TO, T2, etc. in FIG. 11) of the PDU to the base station 703 (e.g., the second network node). In such aspects, to receive the delivery time information (e.g., 1108 in FIG. 11), the base station 704 (e.g., the first network node) may be configured to receive the delivery time information (e.g., 1108 at T1 in FIG. 11) in a downlink data delivery status frame from the base station 703 (e.g., the second network node). The PDU set information 710 (e.g., 808 in FIG. 8; 908 in FIG. 9; 1208 in FIG. 12) may include an indication of a synchronization threshold time (e.g., 1014 in FIG. 10; 1114 in FIG. 11, 1214 in FIG. 12) for the first PDU set (e.g., A in FIGS. 10, 11, 12) and a threshold expiry time (e.g., 1110 in FIG. 11; 1210 in FIG. 12) of the synchronization threshold time (e.g., 1014 in FIG. 10; 1114 in FIG. 11, 1214 in FIG. 12). Accordingly, to provide the PDU set information 710 (e.g., 808 in FIG. 8; 908 in FIG. 9; 1208 in FIG. 12), the base station 704 may be configured to provide the PDU set information 710 (e.g., 808 in FIG. 8; 908 in FIG. 9; 1208 in FIG. 12) per PDU set or per PDU. In some aspects, the indication of the threshold expiry time (e.g., 1110 in FIG. 11; 1210 in FIG. 12) may be based on at least one of a time remaining (e.g., 812 in FIG. 8; 912 in FIG. 9; 1212 in FIG. 12) until the threshold expiry time (e.g., 1110 in FIG. 11; 1210 in FIG. 12) or a network time (e.g., 818 in FIG. 8) corresponding to the threshold expiry time (e.g., 1110 in FIG. 11; 1210 in FIG. 12). In some aspects, the indication of the synchronization threshold time (e.g., 1014 in FIG. 10; 1114 in FIG. 11, 1214 in FIG. 12) may be indicative of an occurrence (e.g., 909 in FIG. 9; 1209 in FIG. 12) of the threshold expiry time (e.g., 1110 in FIG. 11; 1210 in FIG. 12). The time remaining (e.g., 812 in FIG. 8; 912 in FIG. 9; 1212 in FIG. 12) until the threshold expiry time (e.g., 1110 in FIG. 11; 1210 in FIG. 12) may be associated with a first time difference between (i) the synchronization threshold time (e.g., 1014 in FIG. 10; 1114 in FIG. 11; 1214 in FIG. 12) and (ii) a second time difference between a provision time (e.g., TO in FIGS. 8, 11) of the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) of the associated PDU set and a delivery time (e.g., T2, T3 in FIG. 8) of the associated PDU set to the UE 702. In some aspects, the network time (e.g., 818 in FIG. 8) corresponding to the threshold expiry time (e.g., 1110 in FIG. 11; 1210 in FIG. 12) may be based on at least one of a radio frame number or a slot number within a radio frame associated with the radio frame number. In some aspects, the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) may include, based on the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) having at least one PDU (e.g., PDUs 0, 1, 2, 3, 4 in FIG. 13) other than an end PDU (e.g., PDU 5, 1306 in FIG. 13), at least one of (i) the end PDU (e.g., PDU 5, 1306 in FIG. 13) for each PDU set, or (ii) an indication of termination of PDU provision (e.g., 1310 in FIG. 13), for each PDU set, to the base station 703 (e.g., the second network node). The end PDU (e.g., PDU 5, 1306 in FIG. 13) may include a header bit/indication (e.g., 1308 in FIG. 13) indicative of a transmission for the end PDU (e.g., PDU 5, 1306 in FIG. 13) from the base station 703 (e.g., the second network node), and the second subset of remaining PDUs 712 (e.g., 806 in FIG. 8; 906 in FIG. 9; 1006 in FIG. 10; 1106 in FIG. 11; 1206 in FIG. 12) may further include the end PDU (e.g., PDU 5, 1306 in FIG. 13) in association with a value of the header bit/indication (e.g., 1308 in FIG. 13). In some aspects, the indication of termination of PDU provision (e.g., 1310 in FIG. 13) may be included in a downlink user data frame. The end PDU (e.g., PDU 5, 1306 in FIG. 13) may be also a burst end PDU (e.g., PDU 5, 1306 in FIG. 13) of a PDU burst (e.g., 1350 in FIG. 13). In such aspects, the PDU burst (e.g., 1350 in FIG. 13) may comprise each PDU set (e.g., 1302a to 1302n in FIG. 13) of the at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13), and the indication of termination of PDU provision (e.g., 1310 in FIG. 13) may be indicative of the termination of PDU provision (e.g., 1310 in FIG. 13) for the PDU burst (e.g., 1350 in FIG. 13).

As noted, the base station 704 (e.g., the first network node) may be configured to provide a second subset of remaining PDUs 712 (e.g., 806 in FIG. 8; 906 in FIG. 9; 1006 in FIG. 10; 1106 in FIG. 11; 1206 in FIG. 12) for each PDU set to the UE 702. The base station 703 may be configured to provide/transmit, for the UE 702 and in accordance with an indication of the PSDB for an associated PDU set and a PSDB expiry time (e.g., 810 in FIG. 8; 910 in FIG. 9) for the PDU set information 710 (e.g., 808 in FIG. 8; 908 in FIG. 9; 1208 in FIG. 12), the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) for each PDU set of the at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13).

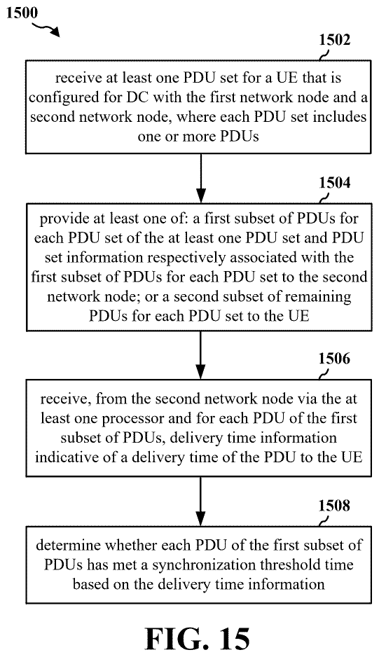

FIG. 15 is a flowchart 1500 of a method of wireless communication. The method may be performed by a first network node/a base station (e.g., the base station 102, 704; the first network node 898, 998, 1098, 1198, 1298, 1398; the network entity 1802, 1902). The method may be for dual connectivity for XR communications. The method may provide for enhanced support of XR with dual connectivity by improving management of PSDBs of PDU sets, synchronization thresholds for multi-modal services, and end PDUs of PDU sets/bursts.

At 1502, the first network node receives at least one PDU set for a UE that is configured for DC with the first network node and a second network node, where each PDU set includes one or more PDUs. As an example, the reception may be performed by one or more of the component 199, the transceiver(s) 1946, and/or the antenna 1980 in FIG. 19. FIG. 7 illustrates, in the context of FIGS. 8-13, an example of a first network node (e.g., the base station 704) receiving such a PDU set(s) from a UPF (e.g., the UPF 705).

In aspects, the base station 704 (e.g., as a first network node) may be configured to receive, and the UPF 705 may be configured to transmit/provide, at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13) for a UE 702 that is configured for DC with the base station 704 and the second base station 703 (e.g., as a second network node). In aspects, each PDU set of the at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13) may include one or more PDUs (e.g., 804, 806 in FIG. 8; 904, 906 in FIG. 9; 1004, 1006 in FIG. 10; 1104, 1106 in FIG. 11; 1204, 1206 in FIG. 12; 1304, 1306 in FIG. 13).

At 1504, the first network node provides at least one of: a first subset of PDUs for each PDU set of the at least one PDU set and PDU set information respectively associated with the first subset of PDUs for each PDU set to the second network node, or a second subset of remaining PDUs for each PDU set to the UE. As an example, the provision may be performed by one or more of the component 199, the transceiver(s) 1946, and/or the antenna 1980 in FIG. 19. FIG. 7 illustrates, in the context of FIGS. 8-13, an example of a first network node (e.g., the base station 704) providing such a first subset of PDUs for a second network node (e.g., the base station 703) and/or providing such second subset of remaining PDUs for a UE (e.g., the UE 702).

In aspects, the base station 704 (e.g., the first network node) may be configured to provide at least one of (i) a first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) for each PDU set of the at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13) and PDU set information 710 (e.g., 808 in FIG. 8; 908 in FIG. 9; 1208 in FIG. 12) respectively associated with the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) for each PDU set to the base station 703 (e.g., the second network node), or (ii) a second subset of remaining PDUs 712 (e.g., 806 in FIG. 8; 906 in FIG. 9; 1006 in FIG. 10; 1106 in FIG. 11; 1206 in FIG. 12) for each PDU set to the UE 702. In aspects, the base station 703 (e.g., the second network node) may be configured to receive, from the base station 704 (e.g., the first network node) and associated with at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13) for the UE 702 that is configured for DC with the base station 704 and the base station 703 (e.g., the first network node and the second network node), the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) for each PDU set of the at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13) and the PDU set information 710 (e.g., 808 in FIG. 8; 908 in FIG. 9; 1208 in FIG. 12) respectively associated with the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) for each PDU set. In aspects, each PDU set includes one or more PDUs (e.g., 804, 806 in FIG. 8; 904, 906 in FIG. 9; 1004, 1006 in FIG. 10; 1104, 1106 in FIG. 11; 1204, 1206 in FIG. 12; 1304, 1306 in FIG. 13). In aspects, the PDU set information 710 (e.g., 808 in FIG. 8; 908 in FIG. 9; 1208 in FIG. 12) may include an indication of a PSDB for an associated PDU set and a PSDB expiry time (e.g., 810 in FIG. 8; 910 in FIG. 9). In aspects, the indication of the PSDB expiry time (e.g., 810 in FIG. 8; 910 in FIG. 9) may be based on at least one of a time remaining (e.g., 812 in FIG. 8; 912 in FIG. 9; 1212 in FIG. 12) until the PSDB expiry time (e.g., 810 in FIG. 8; 910 in FIG. 9) or a network time (e.g., 818 in FIG. 8) corresponding to the PSDB expiry time (e.g., 810 in FIG. 8; 910 in FIG. 9). In aspects, the indication of the PSDB may be/comprise an indication indicative of an occurrence (e.g., 909 in FIG. 9; 1209 in FIG. 12) of the PSDB expiry time (e.g., 810 in FIG. 8; 910 in FIG. 9). The time remaining (e.g., 812, 812a, 812b in FIG. 8; 912 in FIG. 9; 1212 in FIG. 12) until the PSDB expiry time (e.g., 810 in FIG. 8; 910 in FIG. 9) may be associated with a first time difference between (i) the PSDB (e.g., 814 in FIG. 8; 914 in FIG. 9) and (ii) a second time difference between a provision time (e.g., TO in FIGS. 8, 11) of the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) of the associated PDU set and an arrival time (e.g., T2, T3 in FIG. 8) of an initial PDU of the associated PDU set. In some aspects, the network time (e.g., 818 in FIG. 8, 1210 in FIG. 12) corresponding to the PSDB expiry time (e.g., 810 in FIG. 8; 910 in FIG. 9) may be based on at least one of a radio frame number or a slot number within a radio frame associated with the radio frame number.

At 1506, the first network node receives, from the second network node via the at least one processor and for each PDU of the first subset of PDUs, delivery time information indicative of a delivery time of the PDU to the UE. As an example, the reception may be performed by one or more of the component 199, the transceiver(s) 1946, and/or the antenna 1980 in FIG. 19. FIG. 7 illustrates, in the context of FIGS. 8-13, an example of a first network node (e.g., the base station 704) receiving such delivery time information from a second network node (e.g., the base station 703).

In some aspects, the at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13) may be multi-modal (e.g., visual-haptic, audio-haptic, etc.) and may include a first PDU set (e.g., A in FIGS. 10, 11, 12) associated with a first service and a second PDU set (e.g., B in FIGS. 10, 11, 12) associated with a second service that is different from the first service. In such aspects, to provide the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) for each PDU set to the base station 703 (e.g., the second network node), the base station 704 (e.g., the first network node) may be configured to provide, to the base station 703 and in association with a synchronization threshold time (e.g., 1014 in FIG. 10; 1114 in FIG. 11, 1214 in FIG. 12) for the first PDU set (e.g., A in FIGS. 10, 11, 12), the first PDU set (e.g., A in FIGS. 10, 11, 12) associated with the first service and the second PDU set (e.g., B in FIGS. 10, 11, 12) associated with the second service. The PDU set information 710 (e.g., 808 in FIG. 8; 908 in FIG. 9; 1208 in FIG. 12) may include an indication of the synchronization threshold time (e.g., 1014 in FIG. 10; 1114 in FIG. 11, 1214 in FIG. 12) for the first PDU set (e.g., A in FIGS. 10, 11, 12). In some aspects, to provide the second subset of remaining PDUs 712 (e.g., 806 in FIG. 8; 906 in FIG. 9; 1006 in FIG. 10; 1106 in FIG. 11; 1206 in FIG. 12) for each PDU set to the UE 702, the base station 704 may be configured to provide, to the UE 702 and in accordance with the synchronization threshold time (e.g., 1014 in FIG. 10; 1114 in FIG. 11, 1214 in FIG. 12) for the first PDU set (e.g., A in FIGS. 10, 11, 12), the first PDU set (e.g., A in FIGS. 10, 11, 12) associated (e.g., A in FIGS. 10, 11, 12) with the first service and the second PDU set (e.g., B in FIGS. 10, 11, 12) associated with the second service.

In aspects, the base station 704 (e.g., the first network node) may be configured to receive, and the base station 703 (e.g., the second network node) may be configured to transmit/provide, for each PDU of the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13), delivery time information (e.g., 1108 in FIG. 11) indicative of a delivery time (e.g., T1 in FIG. 11) of the PDU to the UE 702.

At 1508, the first network node determines whether each PDU of the first subset of PDUs has met a synchronization threshold time based on the delivery time information. As an example, the determination may be performed by one or more of the component 199, the transceiver(s) 1946, and/or the antenna 1980 in FIG. 19. FIG. 7 illustrates, in the context of FIGS. 8-13, an example of a first network node (e.g., the base station 704) determining a meeting or not for such a synchronization threshold time.

In such aspects, the base station 704 and/or the base station 703 may be configured to determine (e.g., at 1112 in FIG. 11) whether each PDU of the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) has met a synchronization threshold time (e.g., 1014 in FIG. 10; 1114 in FIG. 11, 1214 in FIG. 12) based on the delivery time information (e.g., 1108 in FIG. 11). In some aspects, the delivery time information (e.g., 1108 at T1 in FIG. 11) may indicate at least one of a radio frame number, a slot number within a radio frame associated with the radio frame number, or a time difference between the delivery time (e.g., T1, T3, etc. in FIG. 11) of the PDU to the UE 702 and a provision time (e.g., TO, T2, etc. in FIG. 11) of the PDU to the base station 703 (e.g., the second network node). In such aspects, to receive the delivery time information (e.g., 1108 in FIG. 11), the base station 704 (e.g., the first network node) may be configured to receive the delivery time information (e.g., 1108 at T1 in FIG. 11) in a downlink data delivery status frame from the base station 703 (e.g., the second network node). The PDU set information 710 (e.g., 808 in FIG. 8; 908 in FIG. 9; 1208 in FIG. 12) may include an indication of a synchronization threshold time (e.g., 1014 in FIG. 10; 1114 in FIG. 11, 1214 in FIG. 12) for the first PDU set (e.g., A in FIGS. 10, 11, 12) and a threshold expiry time (e.g., 1110 in FIG. 11; 1210 in FIG. 12) of the synchronization threshold time (e.g., 1014 in FIG. 10; 1114 in FIG. 11, 1214 in FIG. 12). Accordingly, to provide the PDU set information 710 (e.g., 808 in FIG. 8; 908 in FIG. 9; 1208 in FIG. 12), the base station 704 may be configured to provide the PDU set information 710 (e.g., 808 in FIG. 8; 908 in FIG. 9; 1208 in FIG. 12) per PDU set or per PDU. In some aspects, the indication of the threshold expiry time (e.g., 1110 in FIG. 11; 1210 in FIG. 12) may be based on at least one of a time remaining (e.g., 812 in FIG. 8; 912 in FIG. 9; 1212 in FIG. 12) until the threshold expiry time (e.g., 1110 in FIG. 11; 1210 in FIG. 12) or a network time (e.g., 818 in FIG. 8) corresponding to the threshold expiry time (e.g., 1110 in FIG. 11; 1210 in FIG. 12). In some aspects, the indication of the synchronization threshold time (e.g., 1014 in FIG. 10; 1114 in FIG. 11, 1214 in FIG. 12) may be indicative of an occurrence (e.g., 909 in FIG. 9; 1209 in FIG. 12) of the threshold expiry time (e.g., 1110 in FIG. 11; 1210 in FIG. 12). The time remaining (e.g., 812 in FIG. 8; 912 in FIG. 9; 1212 in FIG. 12) until the threshold expiry time (e.g., 1110 in FIG. 11; 1210 in FIG. 12) may be associated with a first time difference between (i) the synchronization threshold time (e.g., 1014 in FIG. 10; 1114 in FIG. 11; 1214 in FIG. 12) and (ii) a second time difference between a provision time (e.g., TO in FIGS. 8, 11) of the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) of the associated PDU set and a delivery time (e.g., T2, T3 in FIG. 8) of the associated PDU set to the UE 702. In some aspects, the network time (e.g., 818 in FIG. 8) corresponding to the threshold expiry time (e.g., 1110 in FIG. 11; 1210 in FIG. 12) may be based on at least one of a radio frame number or a slot number within a radio frame associated with the radio frame number. In some aspects, the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) may include, based on the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) having at least one PDU (e.g., PDUs 0, 1, 2, 3, 4 in FIG. 13) other than an end PDU (e.g., PDU 5, 1306 in FIG. 13), at least one of (i) the end PDU (e.g., PDU 5, 1306 in FIG. 13) for each PDU set, or (ii) an indication of termination of PDU provision (e.g., 1310 in FIG. 13), for each PDU set, to the base station 703 (e.g., the second network node). The end PDU (e.g., PDU 5, 1306 in FIG. 13) may include a header bit/indication (e.g., 1308 in FIG. 13) indicative of a transmission for the end PDU (e.g., PDU 5, 1306 in FIG. 13) from the base station 703 (e.g., the second network node), and the second subset of remaining PDUs 712 (e.g., 806 in FIG. 8; 906 in FIG. 9; 1006 in FIG. 10; 1106 in FIG. 11; 1206 in FIG. 12) may further include the end PDU (e.g., PDU 5, 1306 in FIG. 13) in association with a value of the header bit/indication (e.g., 1308 in FIG. 13). In some aspects, the indication of termination of PDU provision (e.g., 1310 in FIG. 13) may be included in a downlink user data frame. The end PDU (e.g., PDU 5, 1306 in FIG. 13) may be also a burst end PDU (e.g., PDU 5, 1306 in FIG. 13) of a PDU burst (e.g., 1350 in FIG. 13). In such aspects, the PDU burst (e.g., 1350 in FIG. 13) may comprise each PDU set (e.g., 1302a to 1302n in FIG. 13) of the at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13), and the indication of termination of PDU provision (e.g., 1310 in FIG. 13) may be indicative of the termination of PDU provision (e.g., 1310 in FIG. 13) for the PDU burst (e.g., 1350 in FIG. 13).

As noted, the base station 704 (e.g., the first network node) may be configured to provide a second subset of remaining PDUs 712 (e.g., 806 in FIG. 8; 906 in FIG. 9; 1006 in FIG. 10; 1106 in FIG. 11; 1206 in FIG. 12) for each PDU set to the UE 702. The base station 703 may be configured to provide/transmit, for the UE 702 and in accordance with an indication of the PSDB for an associated PDU set and a PSDB expiry time (e.g., 810 in FIG. 8; 910 in FIG. 9) for the PDU set information 710 (e.g., 808 in FIG. 8; 908 in FIG. 9; 1208 in FIG. 12), the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) for each PDU set of the at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13).

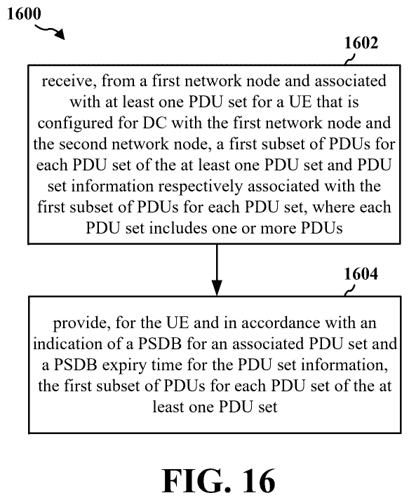

FIG. 16 is a flowchart 1600 of a method of wireless communication. The method may be performed by a first network node/a base station (e.g., the base station 102, 704; the first network node 898, 998, 1098, 1198, 1298, 1398; the network entity 1802, 1902). The method may be for dual connectivity for XR communications. The method may provide for enhanced support of XR with dual connectivity by improving management of PSDBs of PDU sets, synchronization thresholds for multi-modal services, and end PDUs of PDU sets/bursts.

At 1602, the second network node receives, from a first network node and associated with at least one PDU set for a UE that is configured for DC with the first network node and the second network node, a first subset of PDUs for each PDU set of the at least one PDU set and PDU set information respectively associated with the first subset of PDUs for each PDU set, where each PDU set includes one or more PDUs. As an example, the reception may be performed by one or more of the component 199, the transceiver(s) 1946, and/or the antenna 1980 in FIG. 19. FIG. 7 illustrates, in the context of FIGS. 8-13, an example of a second network node (e.g., the base station 703) receiving such a PDU set(s) from a first network node (e.g., the base station 704).

In aspects, the base station 704 (e.g., as a first network node) may be configured to receive, and the UPF 705 may be configured to transmit/provide, at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13) for a UE 702 that is configured for DC with the base station 704 and the second base station 703 (e.g., as a second network node). In aspects, each PDU set of the at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13) may include one or more PDUs (e.g., 804, 806 in FIG. 8; 904, 906 in FIG. 9; 1004, 1006 in FIG. 10; 1104, 1106 in FIG. 11; 1204, 1206 in FIG. 12; 1304, 1306 in FIG. 13). In aspects, the base station 704 (e.g., the first network node) may be configured to provide at least one of (i) a first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) for each PDU set of the at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13) and PDU set information 710 (e.g., 808 in FIG. 8; 908 in FIG. 9; 1208 in FIG. 12) respectively associated with the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) for each PDU set to the base station 703 (e.g., the second network node), or (ii) a second subset of remaining PDUs 712 (e.g., 806 in FIG. 8; 906 in FIG. 9; 1006 in FIG. 10; 1106 in FIG. 11; 1206 in FIG. 12) for each PDU set to the UE 702. In aspects, the base station 703 (e.g., the second network node) may be configured to receive, from the base station 704 (e.g., the first network node) and associated with at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13) for the UE 702 that is configured for DC with the base station 704 and the base station 703 (e.g., the first network node and the second network node), the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) for each PDU set of the at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13) and the PDU set information 710 (e.g., 808 in FIG. 8; 908 in FIG. 9; 1208 in FIG. 12) respectively associated with the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) for each PDU set. In aspects, each PDU set includes one or more PDUs (e.g., 804, 806 in FIG. 8; 904, 906 in FIG. 9; 1004, 1006 in FIG. 10; 1104, 1106 in FIG. 11; 1204, 1206 in FIG. 12; 1304, 1306 in FIG. 13).

In aspects, the PDU set information 710 (e.g., 808 in FIG. 8; 908 in FIG. 9; 1208 in FIG. 12) may include an indication of a PSDB for an associated PDU set and a PSDB expiry time (e.g., 810 in FIG. 8; 910 in FIG. 9). In aspects, the indication of the PSDB expiry time (e.g., 810 in FIG. 8; 910 in FIG. 9) may be based on at least one of a time remaining (e.g., 812 in FIG. 8; 912 in FIG. 9; 1212 in FIG. 12) until the PSDB expiry time (e.g., 810 in FIG. 8; 910 in FIG. 9) or a network time (e.g., 818 in FIG. 8) corresponding to the PSDB expiry time (e.g., 810 in FIG. 8; 910 in FIG. 9). In aspects, the indication of the PSDB may be/comprise an indication indicative of an occurrence (e.g., 909 in FIG. 9; 1209 in FIG. 12) of the PSDB expiry time (e.g., 810 in FIG. 8; 910 in FIG. 9). The time remaining (e.g., 812, 812a, 812b in FIG. 8; 912 in FIG. 9; 1212 in FIG. 12) until the PSDB expiry time (e.g., 810 in FIG. 8; 910 in FIG. 9) may be associated with a first time difference between (i) the PSDB (e.g., 814 in FIG. 8; 914 in FIG. 9) and (ii) a second time difference between a provision time (e.g., TO in FIGS. 8, 11) of the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) of the associated PDU set and an arrival time (e.g., T2, T3 in FIG. 8) of an initial PDU of the associated PDU set. In some aspects, the network time (e.g., 818 in FIG. 8, 1210 in FIG. 12) corresponding to the PSDB expiry time (e.g., 810 in FIG. 8; 910 in FIG. 9) may be based on at least one of a radio frame number or a slot number within a radio frame associated with the radio frame number.

In some aspects, the at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13) may be multi-modal (e.g., visual-haptic, audio-haptic, etc.) and may include a first PDU set (e.g., A in FIGS. 10, 11, 12) associated with a first service and a second PDU set (e.g., B in FIGS. 10, 11, 12) associated with a second service that is different from the first service. In such aspects, to provide the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) for each PDU set to the base station 703 (e.g., the second network node), the base station 704 (e.g., the first network node) may be configured to provide, to the base station 703 and in association with a synchronization threshold time (e.g., 1014 in FIG. 10; 1114 in FIG. 11, 1214 in FIG. 12) for the first PDU set (e.g., A in FIGS. 10, 11, 12), the first PDU set (e.g., A in FIGS. 10, 11, 12) associated with the first service and the second PDU set (e.g., B in FIGS. 10, 11, 12) associated with the second service. The PDU set information 710 (e.g., 808 in FIG. 8; 908 in FIG. 9; 1208 in FIG. 12) may include an indication of the synchronization threshold time (e.g., 1014 in FIG. 10; 1114 in FIG. 11, 1214 in FIG. 12) for the first PDU set (e.g., A in FIGS. 10, 11, 12). In some aspects, to provide the second subset of remaining PDUs 712 (e.g., 806 in FIG. 8; 906 in FIG. 9; 1006 in FIG. 10; 1106 in FIG. 11; 1206 in FIG. 12) for each PDU set to the UE 702, the base station 704 may be configured to provide, to the UE 702 and in accordance with the synchronization threshold time (e.g., 1014 in FIG. 10; 1114 in FIG. 11, 1214 in FIG. 12) for the first PDU set (e.g., A in FIGS. 10, 11, 12), the first PDU set (e.g., A in FIGS. 10, 11, 12) associated (e.g., A in FIGS. 10, 11, 12) with the first service and the second PDU set (e.g., B in FIGS. 10, 11, 12) associated with the second service.

In aspects, the base station 704 (e.g., the first network node) may be configured to receive, and the base station 703 (e.g., the second network node) may be configured to transmit/provide, for each PDU of the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13), delivery time information (e.g., 1108 in FIG. 11) indicative of a delivery time (e.g., T1 in FIG. 11) of the PDU to the UE 702. In such aspects, the base station 704 and/or the base station 703 may be configured to determine (e.g., at 1112 in FIG. 11) whether each PDU of the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) has met a synchronization threshold time (e.g., 1014 in FIG. 10; 1114 in FIG. 11, 1214 in FIG. 12) based on the delivery time information (e.g., 1108 in FIG. 11). In some aspects, the delivery time information (e.g., 1108 at T1 in FIG. 11) may indicate at least one of a radio frame number, a slot number within a radio frame associated with the radio frame number, or a time difference between the delivery time (e.g., T1, T3, etc. in FIG. 11) of the PDU to the UE 702 and a provision time (e.g., TO, T2, etc. in FIG. 11) of the PDU to the base station 703 (e.g., the second network node). In such aspects, to receive the delivery time information (e.g., 1108 in FIG. 11), the base station 704 (e.g., the first network node) may be configured to receive the delivery time information (e.g., 1108 at T1 in FIG. 11) in a downlink data delivery status frame from the base station 703 (e.g., the second network node). The PDU set information 710 (e.g., 808 in FIG. 8; 908 in FIG. 9; 1208 in FIG. 12) may include an indication of a synchronization threshold time (e.g., 1014 in FIG. 10; 1114 in FIG. 11, 1214 in FIG. 12) for the first PDU set (e.g., A in FIGS. 10, 11, 12) and a threshold expiry time (e.g., 1110 in FIG. 11; 1210 in FIG. 12) of the synchronization threshold time (e.g., 1014 in FIG. 10; 1114 in FIG. 11, 1214 in FIG. 12). Accordingly, to provide the PDU set information 710 (e.g., 808 in FIG. 8; 908 in FIG. 9; 1208 in FIG. 12), the base station 704 may be configured to provide the PDU set information 710 (e.g., 808 in FIG. 8; 908 in FIG. 9; 1208 in FIG. 12) per PDU set or per PDU. In some aspects, the indication of the threshold expiry time (e.g., 1110 in FIG. 11; 1210 in FIG. 12) may be based on at least one of a time remaining (e.g., 812 in FIG. 8; 912 in FIG. 9; 1212 in FIG. 12) until the threshold expiry time (e.g., 1110 in FIG. 11; 1210 in FIG. 12) or a network time (e.g., 818 in FIG. 8) corresponding to the threshold expiry time (e.g., 1110 in FIG. 11; 1210 in FIG. 12). In some aspects, the indication of the synchronization threshold time (e.g., 1014 in FIG. 10; 1114 in FIG. 11, 1214 in FIG. 12) may be indicative of an occurrence (e.g., 909 in FIG. 9; 1209 in FIG. 12) of the threshold expiry time (e.g., 1110 in FIG. 11; 1210 in FIG. 12). The time remaining (e.g., 812 in FIG. 8; 912 in FIG. 9; 1212 in FIG. 12) until the threshold expiry time (e.g., 1110 in FIG. 11; 1210 in FIG. 12) may be associated with a first time difference between (i) the synchronization threshold time (e.g., 1014 in FIG. 10; 1114 in FIG. 11; 1214 in FIG. 12) and (ii) a second time difference between a provision time (e.g., TO in FIGS. 8, 11) of the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) of the associated PDU set and a delivery time (e.g., T2, T3 in FIG. 8) of the associated PDU set to the UE 702. In some aspects, the network time (e.g., 818 in FIG. 8) corresponding to the threshold expiry time (e.g., 1110 in FIG. 11; 1210 in FIG. 12) may be based on at least one of a radio frame number or a slot number within a radio frame associated with the radio frame number. In some aspects, the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) may include, based on the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) having at least one PDU (e.g., PDUs 0, 1, 2, 3, 4 in FIG. 13) other than an end PDU (e.g., PDU 5, 1306 in FIG. 13), at least one of (i) the end PDU (e.g., PDU 5, 1306 in FIG. 13) for each PDU set, or (ii) an indication of termination of PDU provision (e.g., 1310 in FIG. 13), for each PDU set, to the base station 703 (e.g., the second network node). The end PDU (e.g., PDU 5, 1306 in FIG. 13) may include a header bit/indication (e.g., 1308 in FIG. 13) indicative of a transmission for the end PDU (e.g., PDU 5, 1306 in FIG. 13) from the base station 703 (e.g., the second network node), and the second subset of remaining PDUs 712 (e.g., 806 in FIG. 8; 906 in FIG. 9; 1006 in FIG. 10; 1106 in FIG. 11; 1206 in FIG. 12) may further include the end PDU (e.g., PDU 5, 1306 in FIG. 13) in association with a value of the header bit/indication (e.g., 1308 in FIG. 13). In some aspects, the indication of termination of PDU provision (e.g., 1310 in FIG. 13) may be included in a downlink user data frame. The end PDU (e.g., PDU 5, 1306 in FIG. 13) may be also a burst end PDU (e.g., PDU 5, 1306 in FIG. 13) of a PDU burst (e.g., 1350 in FIG. 13). In such aspects, the PDU burst (e.g., 1350 in FIG. 13) may comprise each PDU set (e.g., 1302a to 1302n in FIG. 13) of the at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13), and the indication of termination of PDU provision (e.g., 1310 in FIG. 13) may be indicative of the termination of PDU provision (e.g., 1310 in FIG. 13) for the PDU burst (e.g., 1350 in FIG. 13).

At 1604, the second network node provides, for the UE and in accordance with an indication of a PSDB for an associated PDU set and a PSDB expiry time for the PDU set information, the first subset of PDUs for each PDU set of the at least one PDU set. As an example, the provision may be performed by one or more of the component 199, the transceiver(s) 1946, and/or the antenna 1980 in FIG. 19. FIG. 7 illustrates, in the context of FIGS. 8-13, an example of a second network node (e.g., the base station 703) providing such a first subset of PDUs for a UE (e.g., the UE 702).

As noted, the base station 704 (e.g., the first network node) may be configured to provide a second subset of remaining PDUs 712 (e.g., 806 in FIG. 8; 906 in FIG. 9; 1006 in FIG. 10; 1106 in FIG. 11; 1206 in FIG. 12) for each PDU set to the UE 702. The base station 703 may be configured to provide/transmit, for the UE 702 and in accordance with an indication of the PSDB for an associated PDU set and a PSDB expiry time (e.g., 810 in FIG. 8; 910 in FIG. 9) for the PDU set information 710 (e.g., 808 in FIG. 8; 908 in FIG. 9; 1208 in FIG. 12), the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) for each PDU set of the at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13).

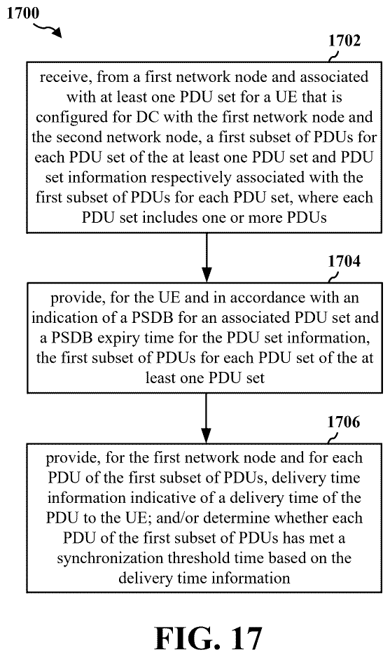

FIG. 17 is a flowchart 1700 of a method of wireless communication. The method may be performed by a first network node/a base station (e.g., the base station 102, 704; the first network node 898, 998, 1098, 1198, 1298, 1398; the network entity 1802, 1902). The method may be for dual connectivity for XR communications. The method may provide for enhanced support of XR with dual connectivity by improving management of PSDBs of PDU sets, synchronization thresholds for multi-modal services, and end PDUs of PDU sets/bursts.

At 1702, the second network node receives, from a first network node and associated with at least one PDU set for a UE that is configured for DC with the first network node and the second network node, a first subset of PDUs for each PDU set of the at least one PDU set and PDU set information respectively associated with the first subset of PDUs for each PDU set, where each PDU set includes one or more PDUs. As an example, the reception may be performed by one or more of the component 199, the transceiver(s) 1946, and/or the antenna 1980 in FIG. 19. FIG. 7 illustrates, in the context of FIGS. 8-13, an example of a second network node (e.g., the base station 703) receiving such a PDU set(s) from a first network node (e.g., the base station 704).

In aspects, the base station 704 (e.g., as a first network node) may be configured to receive, and the UPF 705 may be configured to transmit/provide, at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13) for a UE 702 that is configured for DC with the base station 704 and the second base station 703 (e.g., as a second network node). In aspects, each PDU set of the at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13) may include one or more PDUs (e.g., 804, 806 in FIG. 8; 904, 906 in FIG. 9; 1004, 1006 in FIG. 10; 1104, 1106 in FIG. 11; 1204, 1206 in FIG. 12; 1304, 1306 in FIG. 13). In aspects, the base station 704 (e.g., the first network node) may be configured to provide at least one of (i) a first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) for each PDU set of the at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13) and PDU set information 710 (e.g., 808 in FIG. 8; 908 in FIG. 9; 1208 in FIG. 12) respectively associated with the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) for each PDU set to the base station 703 (e.g., the second network node), or (ii) a second subset of remaining PDUs 712 (e.g., 806 in FIG. 8; 906 in FIG. 9; 1006 in FIG. 10; 1106 in FIG. 11; 1206 in FIG. 12) for each PDU set to the UE 702. In aspects, the base station 703 (e.g., the second network node) may be configured to receive, from the base station 704 (e.g., the first network node) and associated with at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13) for the UE 702 that is configured for DC with the base station 704 and the base station 703 (e.g., the first network node and the second network node), the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) for each PDU set of the at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13) and the PDU set information 710 (e.g., 808 in FIG. 8; 908 in FIG. 9; 1208 in FIG. 12) respectively associated with the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) for each PDU set. In aspects, each PDU set includes one or more PDUs (e.g., 804, 806 in FIG. 8; 904, 906 in FIG. 9; 1004, 1006 in FIG. 10; 1104, 1106 in FIG. 11; 1204, 1206 in FIG. 12; 1304, 1306 in FIG. 13).

In aspects, the PDU set information 710 (e.g., 808 in FIG. 8; 908 in FIG. 9; 1208 in FIG. 12) may include an indication of a PSDB for an associated PDU set and a PSDB expiry time (e.g., 810 in FIG. 8; 910 in FIG. 9). In aspects, the indication of the PSDB expiry time (e.g., 810 in FIG. 8; 910 in FIG. 9) may be based on at least one of a time remaining (e.g., 812 in FIG. 8; 912 in FIG. 9; 1212 in FIG. 12) until the PSDB expiry time (e.g., 810 in FIG. 8; 910 in FIG. 9) or a network time (e.g., 818 in FIG. 8) corresponding to the PSDB expiry time (e.g., 810 in FIG. 8; 910 in FIG. 9). In aspects, the indication of the PSDB may be/comprise an indication indicative of an occurrence (e.g., 909 in FIG. 9; 1209 in FIG. 12) of the PSDB expiry time (e.g., 810 in FIG. 8; 910 in FIG. 9). The time remaining (e.g., 812, 812a, 812b in FIG. 8; 912 in FIG. 9; 1212 in FIG. 12) until the PSDB expiry time (e.g., 810 in FIG. 8; 910 in FIG. 9) may be associated with a first time difference between (i) the PSDB (e.g., 814 in FIG. 8; 914 in FIG. 9) and (ii) a second time difference between a provision time (e.g., TO in FIGS. 8, 11) of the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) of the associated PDU set and an arrival time (e.g., T2, T3 in FIG. 8) of an initial PDU of the associated PDU set. In some aspects, the network time (e.g., 818 in FIG. 8, 1210 in FIG. 12) corresponding to the PSDB expiry time (e.g., 810 in FIG. 8; 910 in FIG. 9) may be based on at least one of a radio frame number or a slot number within a radio frame associated with the radio frame number.

In some aspects, the at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13) may be multi-modal (e.g., visual-haptic, audio-haptic, etc.) and may include a first PDU set (e.g., A in FIGS. 10, 11, 12) associated with a first service and a second PDU set (e.g., B in FIGS. 10, 11, 12) associated with a second service that is different from the first service. In such aspects, to provide the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) for each PDU set to the base station 703 (e.g., the second network node), the base station 704 (e.g., the first network node) may be configured to provide, to the base station 703 and in association with a synchronization threshold time (e.g., 1014 in FIG. 10; 1114 in FIG. 11, 1214 in FIG. 12) for the first PDU set (e.g., A in FIGS. 10, 11, 12), the first PDU set (e.g., A in FIGS. 10, 11, 12) associated with the first service and the second PDU set (e.g., B in FIGS. 10, 11, 12) associated with the second service. The PDU set information 710 (e.g., 808 in FIG. 8; 908 in FIG. 9; 1208 in FIG. 12) may include an indication of the synchronization threshold time (e.g., 1014 in FIG. 10; 1114 in FIG. 11, 1214 in FIG. 12) for the first PDU set (e.g., A in FIGS. 10, 11, 12). In some aspects, to provide the second subset of remaining PDUs 712 (e.g., 806 in FIG. 8; 906 in FIG. 9; 1006 in FIG. 10; 1106 in FIG. 11; 1206 in FIG. 12) for each PDU set to the UE 702, the base station 704 may be configured to provide, to the UE 702 and in accordance with the synchronization threshold time (e.g., 1014 in FIG. 10; 1114 in FIG. 11, 1214 in FIG. 12) for the first PDU set (e.g., A in FIGS. 10, 11, 12), the first PDU set (e.g., A in FIGS. 10, 11, 12) associated (e.g., A in FIGS. 10, 11, 12) with the first service and the second PDU set (e.g., B in FIGS. 10, 11, 12) associated with the second service.

At 1704, the second network node provides, for the UE and in accordance with an indication of a PSDB for an associated PDU set and a PSDB expiry time for the PDU set information, the first subset of PDUs for each PDU set of the at least one PDU set. As an example, the provision may be performed by one or more of the component 199, the transceiver(s) 1946, and/or the antenna 1980 in FIG. 19. FIG. 7 illustrates, in the context of FIGS. 8-13, an example of a second network node (e.g., the base station 703) providing such a first subset of PDUs for a UE (e.g., the UE 702).

As noted, the base station 704 (e.g., the first network node) may be configured to provide a second subset of remaining PDUs 712 (e.g., 806 in FIG. 8; 906 in FIG. 9; 1006 in FIG. 10; 1106 in FIG. 11; 1206 in FIG. 12) for each PDU set to the UE 702. The base station 703 may be configured to provide/transmit, for the UE 702 and in accordance with an indication of the PSDB for an associated PDU set and a PSDB expiry time (e.g., 810 in FIG. 8; 910 in FIG. 9) for the PDU set information 710 (e.g., 808 in FIG. 8; 908 in FIG. 9; 1208 in FIG. 12), the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) for each PDU set of the at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13).

At 1706, the second network node provides, for the first network node and for each PDU of the first subset of PDUs, delivery time information indicative of a delivery time of the PDU to the UE, and/or determines whether each PDU of the first subset of PDUs has met a synchronization threshold time based on the delivery time information. As an example, the provision and/or determination may be performed by one or more of the component 199, the transceiver(s) 1946, and/or the antenna 1980 in FIG. 19. FIG. 7 illustrates, in the context of FIGS. 8-13, an example of a second network node (e.g., the base station 703) providing such delivery time information for a first network node (e.g., the base station 704) and/or determining whether such a synchronization threshold time is met.

In aspects, the base station 704 (e.g., the first network node) may be configured to receive, and the base station 703 (e.g., the second network node) may be configured to transmit/provide, for each PDU of the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13), delivery time information (e.g., 1108 in FIG. 11) indicative of a delivery time (e.g., T1 in FIG. 11) of the PDU to the UE 702. In such aspects, the base station 704 and/or the base station 703 may be configured to determine (e.g., at 1112 in FIG. 11) whether each PDU of the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) has met a synchronization threshold time (e.g., 1014 in FIG. 10; 1114 in FIG. 11, 1214 in FIG. 12) based on the delivery time information (e.g., 1108 in FIG. 11). In some aspects, the delivery time information (e.g., 1108 at T1 in FIG. 11) may indicate at least one of a radio frame number, a slot number within a radio frame associated with the radio frame number, or a time difference between the delivery time (e.g., T1, T3, etc. in FIG. 11) of the PDU to the UE 702 and a provision time (e.g., TO, T2, etc. in FIG. 11) of the PDU to the base station 703 (e.g., the second network node). In such aspects, to receive the delivery time information (e.g., 1108 in FIG. 11), the base station 704 (e.g., the first network node) may be configured to receive the delivery time information (e.g., 1108 at T1 in FIG. 11) in a downlink data delivery status frame from the base station 703 (e.g., the second network node). The PDU set information 710 (e.g., 808 in FIG. 8; 908 in FIG. 9; 1208 in FIG. 12) may include an indication of a synchronization threshold time (e.g., 1014 in FIG. 10; 1114 in FIG. 11, 1214 in FIG. 12) for the first PDU set (e.g., A in FIGS. 10, 11, 12) and a threshold expiry time (e.g., 1110 in FIG. 11; 1210 in FIG. 12) of the synchronization threshold time (e.g., 1014 in FIG. 10; 1114 in FIG. 11, 1214 in FIG. 12). Accordingly, to provide the PDU set information 710 (e.g., 808 in FIG. 8; 908 in FIG. 9; 1208 in FIG. 12), the base station 704 may be configured to provide the PDU set information 710 (e.g., 808 in FIG. 8; 908 in FIG. 9; 1208 in FIG. 12) per PDU set or per PDU. In some aspects, the indication of the threshold expiry time (e.g., 1110 in FIG. 11; 1210 in FIG. 12) may be based on at least one of a time remaining (e.g., 812 in FIG. 8; 912 in FIG. 9; 1212 in FIG. 12) until the threshold expiry time (e.g., 1110 in FIG. 11; 1210 in FIG. 12) or a network time (e.g., 818 in FIG. 8) corresponding to the threshold expiry time (e.g., 1110 in FIG. 11; 1210 in FIG. 12). In some aspects, the indication of the synchronization threshold time (e.g., 1014 in FIG. 10; 1114 in FIG. 11, 1214 in FIG. 12) may be indicative of an occurrence (e.g., 909 in FIG. 9; 1209 in FIG. 12) of the threshold expiry time (e.g., 1110 in FIG. 11; 1210 in FIG. 12). The time remaining (e.g., 812 in FIG. 8; 912 in FIG. 9; 1212 in FIG. 12) until the threshold expiry time (e.g., 1110 in FIG. 11; 1210 in FIG. 12) may be associated with a first time difference between (i) the synchronization threshold time (e.g., 1014 in FIG. 10; 1114 in FIG. 11; 1214 in FIG. 12) and (ii) a second time difference between a provision time (e.g., TO in FIGS. 8, 11) of the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) of the associated PDU set and a delivery time (e.g., T2, T3 in FIG. 8) of the associated PDU set to the UE 702. In some aspects, the network time (e.g., 818 in FIG. 8) corresponding to the threshold expiry time (e.g., 1110 in FIG. 11; 1210 in FIG. 12) may be based on at least one of a radio frame number or a slot number within a radio frame associated with the radio frame number. In some aspects, the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) may include, based on the first subset of PDUs 708 (e.g., 804 in FIG. 8; 904 in FIG. 9; 1004 in FIG. 10; 1104 in FIG. 11; 1204 in FIG. 12; 1302a, 1302n, 1304 in FIG. 13) having at least one PDU (e.g., PDUs 0, 1, 2, 3, 4 in FIG. 13) other than an end PDU (e.g., PDU 5, 1306 in FIG. 13), at least one of (i) the end PDU (e.g., PDU 5, 1306 in FIG. 13) for each PDU set, or (ii) an indication of termination of PDU provision (e.g., 1310 in FIG. 13), for each PDU set, to the base station 703 (e.g., the second network node). The end PDU (e.g., PDU 5, 1306 in FIG. 13) may include a header bit/indication (e.g., 1308 in FIG. 13) indicative of a transmission for the end PDU (e.g., PDU 5, 1306 in FIG. 13) from the base station 703 (e.g., the second network node), and the second subset of remaining PDUs 712 (e.g., 806 in FIG. 8; 906 in FIG. 9; 1006 in FIG. 10; 1106 in FIG. 11; 1206 in FIG. 12) may further include the end PDU (e.g., PDU 5, 1306 in FIG. 13) in association with a value of the header bit/indication (e.g., 1308 in FIG. 13). In some aspects, the indication of termination of PDU provision (e.g., 1310 in FIG. 13) may be included in a downlink user data frame. The end PDU (e.g., PDU 5, 1306 in FIG. 13) may be also a burst end PDU (e.g., PDU 5, 1306 in FIG. 13) of a PDU burst (e.g., 1350 in FIG. 13). In such aspects, the PDU burst (e.g., 1350 in FIG. 13) may comprise each PDU set (e.g., 1302a to 1302n in FIG. 13) of the at least one PDU set 706 (e.g., 802 in FIG. 8; 902 in FIG. 9; 1002, 1003 in FIG. 10; 1102, 1103 in FIG. 11; 1202, 1203 in FIG. 12; 1302 in FIG. 13), and the indication of termination of PDU provision (e.g., 1310 in FIG. 13) may be indicative of the termination of PDU provision (e.g., 1310 in FIG. 13) for the PDU burst (e.g., 1350 in FIG. 13).

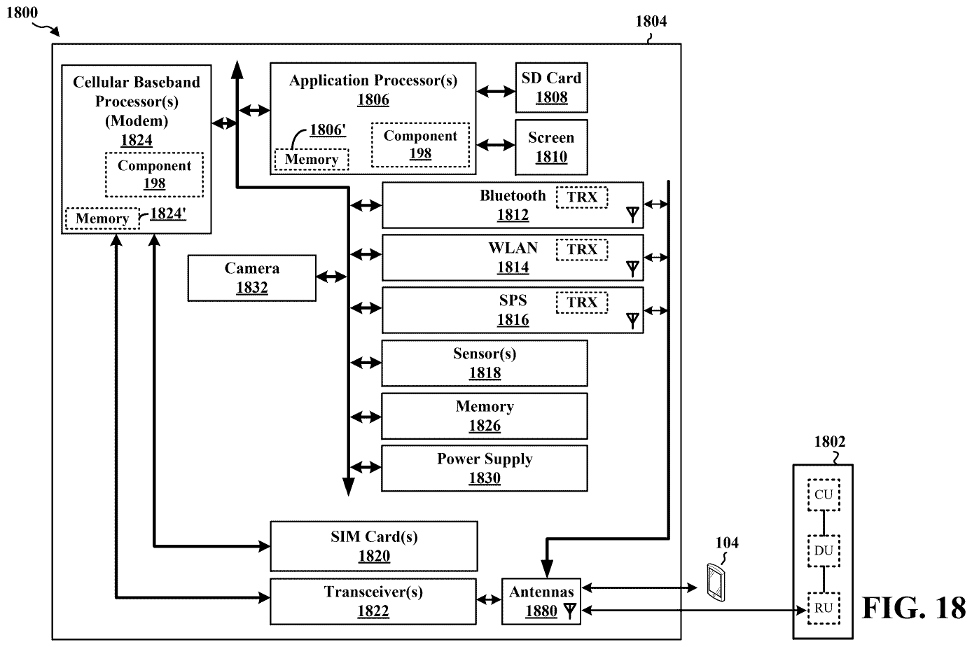

FIG. 18 is a diagram 1800 illustrating an example of a hardware implementation for an apparatus 1804. The apparatus 1804 may be a UE, a component of a UE, or may implement UE functionality. In some aspects, the apparatus 1804 may include at least one cellular baseband processor 1824 (also referred to as a modem) coupled to one or more transceivers 1822 (e.g., cellular RF transceiver). The cellular baseband processor(s) 1824 may include at least one on-chip memory 1824′. In some aspects, the apparatus 1804 may further include one or more subscriber identity modules (SIM) cards 1820 and at least one application processor 1806 coupled to a secure digital (SD) card 1808 and a screen 1810. The application processor(s) 1806 may include on-chip memory 1806′. In some aspects, the apparatus 1804 may further include a Bluetooth module 1812, a WLAN module 1814, an SPS module 1816 (e.g., GNSS module), one or more sensor modules 1818 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1826, a power supply 1830, and/or a camera 1832. The Bluetooth module 1812, the WLAN module 1814, and the SPS module 1816 may include an on-chip transceiver (TRX) (or in some cases, just a receiver (RX)). The Bluetooth module 1812, the WLAN module 1814, and the SPS module 1816 may include their own dedicated antennas and/or utilize the antennas 1880 for communication. The cellular baseband processor(s) 1824 communicates through the transceiver(s) 1822 via one or more antennas 1880 with the UE 104 and/or with an RU associated with a network entity 1802. The cellular baseband processor(s) 1824 and the application processor(s) 1806 may each include a computer-readable medium/memory 1824′, 1806′, respectively. The additional memory modules 1826 may also be considered a computer-readable medium/memory. Each computer-readable medium/memory 1824′, 1806′, 1826 may be non-transitory. The cellular baseband processor(s) 1824 and the application processor(s) 1806 are each responsible for general processing, including the execution of software stored on the computer-readable medium/memory. The software, when executed by the cellular baseband processor(s) 1824/application processor(s) 1806, causes the cellular baseband processor(s) 1824/application processor(s) 1806 to perform the various functions described supra. The cellular baseband processor(s) 1824 and the application processor(s) 1806 are configured to perform the various functions described supra based at least in part of the information stored in the memory. That is, the cellular baseband processor(s) 1824 and the application processor(s) 1806 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1824/application processor(s) 1806 when executing software. The cellular baseband processor(s) 1824/application processor(s) 1806 may be a component of the UE 350 and may include the at least one memory 360 and/or at least one of the TX processor 368, the RX processor 356, and the controller/processor 359. In one configuration, the apparatus 1804 may be at least one processor chip (modem and/or application) and include just the cellular baseband processor(s) 1824 and/or the application processor(s) 1806, and in another configuration, the apparatus 1804 may be the entire UE (e.g., see UE 350 of FIG. 3) and include the additional modules of the apparatus 1804.

As discussed supra, the component 198 may be configured to receive a first subset of PDUs for each PDU set of at least one PDU set from a second network node, and to receive a second subset of remaining PDUs for each PDU set from a first network node The component 198 may be further configured to perform any of the aspects described in connection with the flowcharts in any of FIGS. 14, 15, 16, 17 and/or any of the aspects performed by a UE/XR device for any of FIGS. 4-13. The component 198 may be within the cellular baseband processor(s) 1824, the application processor(s) 1806, or both the cellular baseband processor(s) 1824 and the application processor(s) 1806. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1804 may include a variety of components configured for various functions. In one configuration, the apparatus 1804, and in particular the cellular baseband processor(s) 1824 and/or the application processor(s) 1806, may include means for receiving a first subset of PDUs for each PDU set of at least one PDU set from a second network node, and for receiving a second subset of remaining PDUs for each PDU set from a first network node. The means may be the component 198 of the apparatus 1804 configured to perform the functions recited by the means. As described supra, the apparatus 1804 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 19 is a diagram 1900 illustrating an example of a hardware implementation for a network entity 1902. The network entity 1902 may be a BS, a component of a BS, or may implement BS functionality. The network entity 1902 may include at least one of a CU 1910, a DU 1930, or an RU 1940. For example, depending on the layer functionality handled by the component 199, the network entity 1902 may include the CU 1910; both the CU 1910 and the DU 1930; each of the CU 1910, the DU 1930, and the RU 1940; the DU 1930; both the DU 1930 and the RU 1940; or the RU 1940. The CU 1910 may include at least one CU processor 1912. The CU processor(s) 1912 may include on-chip memory 1912′. In some aspects, the CU 1910 may further include additional memory modules 1914 and a communications interface 1918. The CU 1910 communicates with the DU 1930 through a midhaul link, such as an F1 interface. The DU 1930 may include at least one DU processor 1932. The DU processor(s) 1932 may include on-chip memory 1932′. In some aspects, the DU 1930 may further include additional memory modules 1934 and a communications interface 1938. The DU 1930 communicates with the RU 1940 through a fronthaul link. The RU 1940 may include at least one RU processor 1942. The RU processor(s) 1942 may include on-chip memory 1942′. In some aspects, the RU 1940 may further include additional memory modules 1944, one or more transceivers 1946, antennas 1980, and a communications interface 1948. The RU 1940 communicates with the UE 104. The on-chip memory 1912′, 1932′, 1942′ and the additional memory modules 1914, 1934, 1944 may each be considered a computer-readable medium/memory. Each computer-readable medium/memory may be non-transitory. Each of the processors 1912, 1932, 1942 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive at least one PDU set for a UE that is configured for DC with the first network node and a second network node, where each PDU set includes one or more PDUs. The component 199 may be configured to provide at least one of: a first subset of PDUs for each PDU set of the at least one PDU set and PDU set information respectively associated with the first subset of PDUs for each PDU set to the second network node, or a second subset of remaining PDUs for each PDU set to the UE. The component 199 may be configured to receive, from the second network node and for each PDU of the first subset of PDUs, delivery time information indicative of a delivery time of the PDU to the UE. The component 199 may be configured to determine whether each PDU of the first subset of PDUs has met a synchronization threshold time based on the delivery time information. As discussed supra, the component 199 may be configured to receive, from a first network node and associated with at least one PDU set for a UE that is configured for DC with the first network node and the second network node, a first subset of PDUs for each PDU set of the at least one PDU set and PDU set information respectively associated with the first subset of PDUs for each PDU set, where each PDU set includes one or more PDUs. The component 199 may be configured to provide, for the UE and in accordance with an indication of a PPSDB for an associated PDU set and a PSDB expiry time for the PDU set information, the first subset of PDUs for each PDU set of the at least one PDU set. The component 199 may be configured to provide, for the first network node and for each PDU of the first subset of PDUs, delivery time information indicative of a delivery time of the PDU to the UE. The component 199 may be configured to determine whether each PDU of the first subset of PDUs has met a synchronization threshold time based on the delivery time information. The component 199 may be further configured to perform any of the aspects described in connection with the flowcharts in any of FIGS. 14, 15, 16, 17 and/or any of the aspects performed by a network node (e.g., a first and/or a second network node) for any of FIGS. 4-13. The component 199 may be within one or more processors of one or more of the CU 1910, DU 1930, and the RU 1940. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1902 may include a variety of components configured for various functions. In one configuration, the network entity 1902 may include means for receiving at least one PDU set for a UE that is configured for DC with the first network node and a second network node, where each PDU set includes one or more PDUs. In one configuration, the network entity 1902 may include means for providing at least one of: a first subset of PDUs for each PDU set of the at least one PDU set and PDU set information respectively associated with the first subset of PDUs for each PDU set to the second network node, or a second subset of remaining PDUs for each PDU set to the UE. In one configuration, the network entity 1902 may include means for receiving, from the second network node and for each PDU of the first subset of PDUs, delivery time information indicative of a delivery time of the PDU to the UE. In one configuration, the network entity 1902 may include means for determining whether each PDU of the first subset of PDUs has met a synchronization threshold time based on the delivery time information. In one configuration, the network entity 1902 may include means for receiving, from a first network node and associated with at least one PDU set for a UE that is configured for DC with the first network node and the second network node, a first subset of PDUs for each PDU set of the at least one PDU set and PDU set information respectively associated with the first subset of PDUs for each PDU set, where each PDU set includes one or more PDUs. In one configuration, the network entity 1902 may include means for providing, for the UE and in accordance with an indication of a PPSDB for an associated PDU set and a PSDB expiry time for the PDU set information, the first subset of PDUs for each PDU set of the at least one PDU set. In one configuration, the network entity 1902 may include means for providing, for the first network node and for each PDU of the first subset of PDUs, delivery time information indicative of a delivery time of the PDU to the UE. In one configuration, the network entity 1902 may include means for determining whether each PDU of the first subset of PDUs has met a synchronization threshold time based on the delivery time information. The means may be the component 199 of the network entity 1902 configured to perform the functions recited by the means. As described supra, the network entity 1902 may include the TX processor 316, the RX processor 370, and the controller/processor 375. As such, in one configuration, the means may be the TX processor 316, the RX processor 370, and/or the controller/processor 375 configured to perform the functions recited by the means.

Wireless communications over networks between network entities (e.g., network nodes such as base stations, eNBs, gNBs, etc.; entities in a core network such as a UPF), UEs, and/or XR devices may facilitate service data flows from application servers to UEs/XR devices for XR applications. UEs may be, may comprise, and/or may be paired with XR devices to provide user experiences through XR. Wireless communication networks, such as 5G NR among others, may provide a high-speed, low-latency and high-reliability wireless connectivity which can enable latency-sensitive services like the immersive XR multimedia and cloud computing (e.g., AR Glasses, a VR HMD, haptic gloves/other tactile equipment, cloud gaming, cloud AI, and/or the like). In some scenarios, dual-modalities for an XR experience may be used, such as for both video and haptic modalities. Such advanced applications may have high levels for operational/system performance parameters to maintain the user experience, including but without limitation, data rate, latency, power consumption, and/or the like (e.g., a stipulated PDB of 10 ms for XR traffic packets to maintain the user experience). However, support of DC scenarios in NR, and beyond, introduce issues that are not accounted for in the current state of the art. For example, with split bearers, a network node (e.g., a Master Node or a Secondary Node) that receives data from a UPF can transmit the data in the MCG and in the SCG, and if a QoS flow (e.g., for XR) has been configured to carry PDU sets, some of the PDUs can be transmitted in the MCG, while others can be transmitted in the SCG. When a first network node forwards PDUs to a second network node for provision to the UE, current solutions lack mechanisms for the second network node receiving the forwarded PDUs to be aware of information associated with the PSDB/the PSDB expiry time, synchronization thresholds between PDU sets for dual-modalities, end PDU/burst indications, and/or the like. Accordingly, the second network node is unable to efficiently schedule transmission of the forwarded PDUs to the UE, which negatively impacts the XR user experience.

Aspects herein for DC for XR communications improve such issues. Aspects enable a first network node to inform the second network node of a PDU set expiry time for efficient UE transmission scheduling of first subsets of PDUs in DC by providing PDU set information, associated with forwarded first subsets of PDUs for PDU sets to a second network node, as well as information about the PSDB expiry. Aspects enable management of synchronization threshold times in DC by providing associated PDU sets to a UE via a single network node or providing delivery time information for forwarded PDUs from a second to a first network node. Aspects enable enhancements for RRM and scheduling policies for the second network node by providing information associated with end PDUs of PDU sets/bursts from a first network node to a second network node.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first network node, comprising: receiving at least one packet data unit (PDU) set for a user equipment (UE) that is configured for dual connectivity (DC) with the first network node and a second network node, wherein each PDU set includes one or more PDUs; and providing at least one of: a first subset of PDUs for each PDU set of the at least one PDU set and PDU set information respectively associated with the first subset of PDUs for each PDU set to the second network node; or a second subset of remaining PDUs for each PDU set to the UE.

Aspect 2 is the method of aspect 1, wherein the PDU set information includes an indication of a PDU set delay budget (PSDB) for an associated PDU set and a PSDB expiry time.

Aspect 3 is the method of aspect 2, wherein the indication of the PSDB expiry time is based on at least one of a time remaining until the PSDB expiry time or a network time corresponding to the PSDB expiry time; or wherein the indication of the PSDB is indicative of an occurrence of the PSDB expiry time.

Aspect 4 is the method of aspect 3, wherein the time remaining until the PSDB expiry time is associated with a first time difference between (i) the PSDB and (ii) a second time difference between a provision time of the first subset of PDUs of the associated PDU set and an arrival time of an initial PDU of the associated PDU set; or wherein the network time corresponding to the PSDB expiry time is based on at least one of a radio frame number or a slot number within a radio frame associated with the radio frame number.

Aspect 5 is the method of aspect 1, wherein the at least one PDU set is multi-modal and includes a first PDU set associated with a first service and a second PDU set associated with a second service that is different from the first service.

Aspect 6 is the method of aspect 5, wherein providing the first subset of PDUs for each PDU set to the second network node includes providing, to the second network node and in association with a synchronization threshold time for the first PDU set, the first PDU set associated with the first service and the second PDU set associated with the second service, wherein the PDU set information includes an indication of the synchronization threshold time for the first PDU set; or wherein providing the second subset of remaining PDUs for each PDU set to the UE includes providing, to the UE and in accordance with the synchronization threshold time for the first PDU set, the first PDU set associated with the first service and the second PDU set associated with the second service.

Aspect 7 is the method of aspect 5, further comprising: receiving, from the second network node and for each PDU of the first subset of PDUs, delivery time information indicative of a delivery time of the PDU to the UE; and determining whether each PDU of the first subset of PDUs has met a synchronization threshold time based on the delivery time information.

Aspect 8 is the method of aspect 7, wherein the delivery time information indicates at least one of a radio frame number, a slot number within a radio frame associated with the radio frame number, or a time difference between the delivery time of the PDU to the UE and a provision time of the PDU to the second network node.

Aspect 9 is the method of aspect 8, wherein receiving the delivery time information includes receiving the delivery time information in a downlink data delivery status frame from the second network node.

Aspect 10 is the method of aspect 5, wherein the PDU set information includes an indication of a synchronization threshold time for the first PDU set and a threshold expiry time of the synchronization threshold time, wherein providing the PDU set information includes providing the PDU set information per PDU set or per PDU.

Aspect 11 is the method of aspect 10, wherein the indication of the threshold expiry time is based on at least one of a time remaining until the threshold expiry time or a network time corresponding to the threshold expiry time; or wherein the indication of the synchronization threshold time is indicative of an occurrence of the threshold expiry time.

Aspect 12 is the method of aspect 11, wherein the time remaining until the threshold expiry time is associated with a first time difference between (i) the synchronization threshold time and (ii) a second time difference between a provision time of the first subset of PDUs of the associated PDU set and a delivery time of the associated PDU set to the UE; or wherein the network time corresponding to the threshold expiry time is based on at least one of a radio frame number or a slot number within a radio frame associated with the radio frame number.

Aspect 13 is the method of aspect 1, wherein the first subset of PDUs includes, based on the first subset of PDUs having at least one PDU other than an end PDU, at least one of: the end PDU for each PDU set, or an indication of termination of PDU provision, for each PDU set, to the second network node.

Aspect 14 is the method of aspect 13, wherein the end PDU includes a header bit indicative of a transmission for the end PDU from the second network node, wherein the second subset of remaining PDUs further includes the end PDU in association with a value of the header bit; or wherein the indication of termination of PDU provision is included in a downlink user data frame.

Aspect 15 is the method of aspect 14, wherein the end PDU is also a burst end PDU of a PDU burst, wherein the PDU burst comprises each PDU set of the at least one PDU set, and wherein the indication of termination of PDU provision is indicative of the termination of PDU provision for the PDU burst.

Aspect 16 is a method of wireless communication at a second network node, comprising: receiving, from a first network node and associated with at least one packet data unit (PDU) set for a user equipment (UE) that is configured for dual connectivity (DC) with the first network node and the second network node, a first subset of PDUs for each PDU set of the at least one PDU set and PDU set information respectively associated with the first subset of PDUs for each PDU set, wherein each PDU set includes one or more PDUs; and providing, for the UE and in accordance with an indication of a PDU set delay budget (PSDB) for an associated PDU set and a PSDB expiry time for the PDU set information, the first subset of PDUs for each PDU set of the at least one PDU set.

Aspect 17 is the method of aspect 16, wherein the indication of the PSDB expiry time is based on at least one of a time remaining until the PSDB expiry time or a network time corresponding to the PSDB expiry time; or wherein the indication of the PSDB is indicative of an occurrence of the PSDB expiry time.

Aspect 18 is the method of aspect 17, wherein the time remaining until the PSDB expiry time is associated with a first time difference between (i) the PSDB and (ii) a second time difference between a provision time of the first subset of PDUs of the associated PDU set and an arrival time of an initial PDU of the associated PDU set; or wherein the network time corresponding to the PSDB expiry time is based on at least one of a radio frame number or a slot number within a radio frame associated with the radio frame number.

Aspect 19 is the method of aspect 16, wherein the at least one PDU set is multi-modal and includes a first PDU set associated with a first service and a second PDU set associated with a second service that is different from the first service.

Aspect 20 is the method of aspect 19, wherein receiving the first subset of PDUs for each PDU set includes receiving, from the first network node and in association with a synchronization threshold time for the first PDU set, the first PDU set associated with the first service and the second PDU set associated with the second service, wherein the PDU set information includes an additional indication of the synchronization threshold time for the first PDU set.

Aspect 21 is the method of aspect 19, further comprising at least one of: providing, for the first network node and for each PDU of the first subset of PDUs, delivery time information indicative of a delivery time of the PDU to the UE; or determining whether each PDU of the first subset of PDUs has met a synchronization threshold time based on the delivery time information.

Aspect 22 is the method of aspect 21, wherein the delivery time information indicates at least one of a radio frame number, a slot number within a radio frame associated with the radio frame number, or a time difference between the delivery time of the PDU to the UE and a provision time of the PDU to the second network node.

Aspect 23 is the method of aspect 22, wherein providing the delivery time information includes providing the delivery time information in a downlink data delivery status frame from the second network node.

Aspect 24 is the method of aspect 19, wherein the PDU set information includes an additional indication of a synchronization threshold time for the first PDU set and a threshold expiry time of the synchronization threshold time, wherein receiving the PDU set information includes receiving the PDU set information per PDU set or per PDU.

Aspect 25 is the method of aspect 24, wherein the additional indication of the threshold expiry time is based on at least one of a time remaining until the threshold expiry time or a network time corresponding to the threshold expiry time; or wherein the additional indication of the synchronization threshold time is indicative of an occurrence of the threshold expiry time.

Aspect 26 is the method of aspect 25, wherein the time remaining until the threshold expiry time is associated with a first time difference between (i) the synchronization threshold time and (ii) a second time difference between a provision time of the first subset of PDUs of the associated PDU set and a delivery time of the associated PDU set to the UE; or wherein the network time corresponding to the threshold expiry time is based on at least one of a radio frame number or a slot number within a radio frame associated with the radio frame number.

Aspect 27 is the method of aspect 16, wherein the first subset of PDUs includes, based on the first subset of PDUs having at least one PDU other than an end PDU, at least one of: the end PDU for each PDU set, or an additional indication of termination of PDU provision, for each PDU set, from the first network node.

Aspect 28 is the method of aspect 27, including at least one of: wherein the end PDU includes a header bit indicative of a transmission for the end PDU from the second network node; wherein the additional indication of termination of PDU provision is included in a downlink user data frame; or wherein the end PDU is also a burst end PDU of a PDU burst, wherein the PDU burst comprises each PDU set of the at least one PDU set, and wherein the additional indication of termination of PDU provision is indicative of the termination of PDU provision for the PDU burst.

Aspect 29 is an apparatus for wireless communication at a first network node, comprising: at least one memory; and at least one processor coupled to the at least one memory, the at least one processor, individually or in any combination, is configured to perform the method of any of aspects 1 to 15.

Aspect 30 is an apparatus for wireless communication at a first network node, comprising means for performing each step in the method of any of aspects 1 to 15.

Aspect 31 is the apparatus of any of aspects 29 and 30, further comprising a transceiver configured to receive or to transmit in association with the method of any of aspects 1 to 15.

Aspect 32 is a computer-readable medium (e.g., a non-transitory computer-readable medium) storing computer executable code at a first network node, the code when executed by at least one processor causes the at least one processor to perform the method of any of aspects 1 to 15.

Aspect 33 is an apparatus for wireless communication at a second network node, comprising: at least one memory; and at least one processor coupled to the at least one memory, the at least one processor, individually or in any combination, is configured to perform the method of any of aspects 16 to 28.

Aspect 34 is an apparatus for wireless communication at a second network node, comprising means for performing each step in the method of any of aspects 16 to 28.

Aspect 35 is the apparatus of any of aspects 33 and 34, further comprising a transceiver configured to receive or to transmit in association with the method of any of aspects 16 to 28.

Aspect 36 is a computer-readable medium (e.g., a non-transitory computer-readable medium) storing computer executable code at a second network node, the code when executed by at least one processor causes the at least one processor to perform the method of any of aspects 16 to 28.

What is claimed is:

1. An apparatus for wireless communication at a first network node, comprising:
at least one memory; and
at least one processor coupled to the at least one memory and, based at least in part on information stored in the at least one memory, the at least one processor, individually or in any combination, is configured to:
receive at least one packet data unit (PDU) set for a user equipment (UE) that is configured for dual connectivity (DC) with the first network node and a second network node, wherein each PDU set includes one or more PDUs; and
provide at least one of:
a first subset of PDUs for each PDU set of the at least one PDU set and PDU set information respectively associated with the first subset of PDUs for each PDU set to the second network node; or
a second subset of remaining PDUs for each PDU set to the UE.

2. The apparatus of claim 1, wherein the PDU set information includes an indication of a PDU set delay budget (PSDB) for an associated PDU set and a PSDB expiry time.

3. The apparatus of claim 2, wherein the indication of the PSDB expiry time is based on at least one of a time remaining until the PSDB expiry time or a network time corresponding to the PSDB expiry time; or
wherein the indication of the PSDB is indicative of an occurrence of the PSDB expiry time.

4. The apparatus of claim 3, wherein the time remaining until the PSDB expiry time is associated with a first time difference between (i) the PSDB and (ii) a second time difference between a provision time of the first subset of PDUs of the associated PDU set and an arrival time of an initial PDU of the associated PDU set; or
wherein the network time corresponding to the PSDB expiry time is based on at least one of a radio frame number or a slot number within a radio frame associated with the radio frame number.

5. The apparatus of claim 1, wherein the at least one PDU set is multi-modal and includes a first PDU set associated with a first service and a second PDU set associated with a second service that is different from the first service.

6. The apparatus of claim 5, wherein to provide the first subset of PDUs for each PDU set to the second network node, the at least one processor, individually or in any combination, is configured to provide, to the second network node and in association with a synchronization threshold time for the first PDU set, the first PDU set associated with the first service and the second PDU set associated with the second service, wherein the PDU set information includes an indication of the synchronization threshold time for the first PDU set; or
wherein to provide the second subset of remaining PDUs for each PDU set to the UE, the at least one processor, individually or in any combination, is configured to provide, to the UE and in accordance with the synchronization threshold time for the first PDU set, the first PDU set associated with the first service and the second PDU set associated with the second service.

7. The apparatus of claim 5, further comprising at least one transceiver coupled to the at least one processor, wherein the at least one processor, individually or in any combination, is further configured to:
receive, from the second network node via the at least one processor and for each PDU of the first subset of PDUs, delivery time information indicative of a delivery time of the PDU to the UE; and
determine whether each PDU of the first subset of PDUs has met a synchronization threshold time based on the delivery time information.

8. The apparatus of claim 7, wherein the delivery time information indicates at least one of a radio frame number, a slot number within a radio frame associated with the radio frame number, or a time difference between the delivery time of the PDU to the UE and a provision time of the PDU to the second network node.

9. The apparatus of claim 8, wherein to receive the delivery time information, the at least one processor, individually or in any combination, is configured to receive the delivery time information in a downlink data delivery status frame from the second network node.

10. The apparatus of claim 5, wherein the PDU set information includes an indication of a synchronization threshold time for the first PDU set and a threshold expiry time of the synchronization threshold time, wherein to provide the PDU set information, the at least one processor, individually or in any combination, is configured to provide the PDU set information per PDU set or per PDU.

11. The apparatus of claim 10, wherein the indication of the threshold expiry time is based on at least one of a time remaining until the threshold expiry time or a network time corresponding to the threshold expiry time; or
wherein the indication of the synchronization threshold time is indicative of an occurrence of the threshold expiry time.

12. The apparatus of claim 11, wherein the time remaining until the threshold expiry time is associated with a first time difference between (i) the synchronization threshold time and (ii) a second time difference between a provision time of the first subset of PDUs of the associated PDU set and a delivery time of the associated PDU set to the UE; or
wherein the network time corresponding to the threshold expiry time is based on at least one of a radio frame number or a slot number within a radio frame associated with the radio frame number.

13. The apparatus of claim 1, wherein the first subset of PDUs includes, based on the first subset of PDUs having at least one PDU other than an end PDU, at least one of:
the end PDU for each PDU set, or
an indication of termination of PDU provision, for each PDU set, to the second network node.

14. The apparatus of claim 13, wherein the end PDU includes a header bit indicative of a transmission for the end PDU from the second network node, wherein the second subset of remaining PDUs further includes the end PDU in association with a value of the header bit; or
wherein the indication of termination of PDU provision is included in a downlink user data frame.

15. The apparatus of claim 14, wherein the end PDU is also a burst end PDU of a PDU burst, wherein the PDU burst comprises each PDU set of the at least one PDU set, and wherein the indication of termination of PDU provision is indicative of the termination of PDU provision for the PDU burst.

16. An apparatus for wireless communication at a second network node, comprising:
at least one memory; and
at least one processor coupled to the at least one memory and, based at least in part on information stored in the at least one memory, the at least one processor, individually or in any combination, is configured to:
receive, from a first network node and associated with at least one packet data unit (PDU) set for a user equipment (UE) that is configured for dual connectivity (DC) with the first network node and the second network node, a first subset of PDUs for each PDU set of the at least one PDU set and PDU set information respectively associated with the first subset of PDUs for each PDU set, wherein each PDU set includes one or more PDUs; and
provide, for the UE and in accordance with an indication of a PDU set delay budget (PSDB) for an associated PDU set and a PSDB expiry time for the PDU set information, the first subset of PDUs for each PDU set of the at least one PDU set.

17. The apparatus of claim 16, wherein the indication of the PSDB expiry time is based on at least one of a time remaining until the PSDB expiry time or a network time corresponding to the PSDB expiry time; or
wherein the indication of the PSDB is indicative of an occurrence of the PSDB expiry time.

18. The apparatus of claim 17, wherein the time remaining until the PSDB expiry time is associated with a first time difference between (i) the PSDB and (ii) a second time difference between a provision time of the first subset of PDUs of the associated PDU set and an arrival time of an initial PDU of the associated PDU set; or
wherein the network time corresponding to the PSDB expiry time is based on at least one of a radio frame number or a slot number within a radio frame associated with the radio frame number.

19. The apparatus of claim 16, wherein the at least one PDU set is multi-modal and includes a first PDU set associated with a first service and a second PDU set associated with a second service that is different from the first service.

20. The apparatus of claim 19, wherein to receive the first subset of PDUs for each PDU set, the at least one processor, individually or in any combination, is configured to receive, from the first network node and in association with a synchronization threshold time for the first PDU set, the first PDU set associated with the first service and the second PDU set associated with the second service, wherein the PDU set information includes an additional indication of the synchronization threshold time for the first PDU set.

21. The apparatus of claim 19, further comprising at least one transceiver coupled to the at least one processor, wherein the at least one processor, individually or in any combination, is further configured to:
provide, for the first network node via the at least one transceiver and for each PDU of the first subset of PDUs, delivery time information indicative of a delivery time of the PDU to the UE; or
determine whether each PDU of the first subset of PDUs has met a synchronization threshold time based on the delivery time information.

22. The apparatus of claim 21, wherein the delivery time information indicates at least one of a radio frame number, a slot number within a radio frame associated with the radio frame number, or a time difference between the delivery time of the PDU to the UE and a provision time of the PDU to the second network node.

23. The apparatus of claim 22, wherein to provide the delivery time information, the at least one processor, individually or in any combination, is configured to provide the delivery time information in a downlink data delivery status frame from the second network node.

24. The apparatus of claim 19, wherein the PDU set information includes an additional indication of a synchronization threshold time for the first PDU set and a threshold expiry time of the synchronization threshold time, wherein to receive the PDU set information, the at least one processor, individually or in any combination, is configured to receive the PDU set information per PDU set or per PDU.

25. The apparatus of claim 24, wherein the additional indication of the threshold expiry time is based on at least one of a time remaining until the threshold expiry time or a network time corresponding to the threshold expiry time; or
wherein the additional indication of the synchronization threshold time is indicative of an occurrence of the threshold expiry time.

26. The apparatus of claim 25, wherein the time remaining until the threshold expiry time is associated with a first time difference between (i) the synchronization threshold time and (ii) a second time difference between a provision time of the first subset of PDUs of the associated PDU set and a delivery time of the associated PDU set to the UE; or
wherein the network time corresponding to the threshold expiry time is based on at least one of a radio frame number or a slot number within a radio frame associated with the radio frame number.

27. The apparatus of claim 16, wherein the first subset of PDUs includes, based on the first subset of PDUs having at least one PDU other than an end PDU, at least one of:
the end PDU for each PDU set, or
an additional indication of termination of PDU provision, for each PDU set, from the first network node.

28. The apparatus of claim 27, including at least one of:
wherein the end PDU includes a header bit indicative of a transmission for the end PDU from the second network node;
wherein the additional indication of termination of PDU provision is included in a downlink user data frame; or
wherein the end PDU is also a burst end PDU of a PDU burst, wherein the PDU burst comprises each PDU set of the at least one PDU set, and wherein the additional indication of termination of PDU provision is indicative of the termination of PDU provision for the PDU burst.

29. A method of wireless communication at a first network node, comprising:
receiving at least one packet data unit (PDU) set for a user equipment (UE) that is configured for dual connectivity (DC) with the first network node and a second network node, wherein each PDU set includes one or more PDUs; and
providing at least one of:
a first subset of PDUs for each PDU set of the at least one PDU set and PDU set information respectively associated with the first subset of PDUs for each PDU set to the second network node; or
a second subset of remaining PDUs for each PDU set to the UE.

30. A method of wireless communication at a second network node, comprising:
receiving, from a first network node and associated with at least one packet data unit (PDU) set for a user equipment (UE) that is configured for dual connectivity (DC) with the first network node and the second network node, a first subset of PDUs for each PDU set of the at least one PDU set and PDU set information respectively associated with the first subset of PDUs for each PDU set, wherein each PDU set includes one or more PDUs; and
providing, for the UE and in accordance with an indication of a PDU set delay budget (PSDB) for an associated PDU set and a PSDB expiry time for the PDU set information, the first subset of PDUs for each PDU set of the at least one PDU set.
